(19) United States
(12) Patent Application Publication
(10) Pub. No.: US 2026/0002276 A1
(43) Pub. Date: Jan. 1, 2026

(54) METHODS, SYSTEMS, AND DEVICES FOR PURIFYING METAL-CONTAINING MATERIAL

(71) Applicant: FORM ENERGY, INC., Somerville, MA (US)

(72) Inventors: Nicholas Reed Perkins, Cambridge, MA (US); Joseph Stephen Manser, Lowell, MA (US); Robert Morgan, Winchester, MA (US); Jocelyn Newhouse, Somerville, MA (US); Zachariah Norman, Norman, MA (US); Laine Blummer, Watertown, MA (US); Leah Nation, Cambridge, MA (US); Christopher Reynolds, Arlington, MA (US); Annelise Thompson, Somerville, MA (US)

(21) Appl. No.: 19/253,324

(22) Filed: Jun. 27, 2025

Related U.S. Application Data
(60) Provisional application No. 63/665,167, filed on Jun. 27, 2024.
(60) Provisional application No. 63/671,688, filed on Jul. 15, 2024.
(60) Provisional application No. 63/712,984, filed on Oct. 28, 2024.
(60) Provisional application No. 63/741,683, filed on Jan. 3, 2025.
(60) Provisional application No. 63/756,434, filed on Feb. 10, 2025.

(51) Int. Cl. C25C 3/24; C25C 3/04; C25C 3/18; C25C 3/28; C25C 7/06

(52) U.S. Cl. CPC C25C 3/24; C25C 3/04; C25C 3/18; C25C 3/28; C25C 7/06

(57) ABSTRACT

Methods and systems of the present disclosure are generally directed to purification of metal-containing material. For example, soft oxidation may be used to generate an oxygen-free product from a low-quality alloy of a base metal. The oxygen-free product may be electrolyzed directly to generate a higher-quality alloy of the base metal—namely, an alloy with higher weight percentage of the base metal and, thus, lower weight percentage of tramp elements. As compared to recycling the base metal with a metal-air electrochemical cell, the methods and systems of the present disclosure may facilitate forming high-quality recycled metal (e.g., aluminum) using significantly less energy.

### CROSS-REFERENCE TO RELATED APPLICATIONS

This application claims the benefit of priority to U.S. Provisional Patent Application 63/665,167 filed Jun. 27, 2024, U.S. Provisional Patent 63/671,688, filed Jul. 15, 2024, and U.S. Provisional Patent Application 63/712,984, filed Oct. 28, 2024, U.S. Provisional Patent Application 63/741,683, filed Jan. 3, 2025, and U.S. Provisional Patent Application 63/756,434, filed Feb. 10, 2025, with the entire contents of each of these applications hereby incorporated herein by reference.

### BACKGROUND

Scrap aluminum is typically recycled using techniques that substantially increase the fraction of tramp elements (e.g., silicon, magnesium, nickel, zinc, lead, chromium, iron copper, vanadium, and manganese), resulting in recycled aluminum that no longer meets specifications for certain high-value applications, such as those in the automotive and/or aviation industries. Instead, such recycled aluminum may be limited to lower-value end-uses, such as beverage cans. This degradation of the quality of aluminum, and thus its associated value, is sometimes referred to as “downcycling.”

It is possible to react low-quality (e.g., scrap) aluminum with oxygen in a battery or broiler and extract energy while forming aluminum trihydroxide. However, a large amount of energy is required to calcine the aluminum trihydroxide into alumina and then electrolyze the alumina in the Hall-Héroult process (which emits carbon dioxide) to form higher-quality aluminum—namely, an aluminum alloy with a higher weight percentage of aluminum. However, the overall efficiency (sometimes referred to as round-trip efficiency) of this process is low, thus requiring a large amount of energy.

Accordingly, there remains a need for more power-efficient and cost-effective purification of aluminum and/or other light metals at industrial scale.

### SUMMARY

Methods, systems, and devices of the present disclosure are generally directed to purification (e.g., reversible purification) of metal-containing material. For example, soft oxidation may be used to generate an oxygen-free product from a low-quality composition of a base metal. The oxygen-free product may be electrolyzed directly to generate a higher-quality composition of the base metal—namely, an alloy with higher weight percentage of the base metal and, thus, lower weight percentage of tramp elements. As compared to recycling the base metal with a metal-air electrochemical cell, the methods and systems of the present disclosure may facilitate forming high-quality recycled metal (e.g., aluminum) using significantly less energy.

According to one aspect, a method of purifying metal-containing material may include operating a discharge cell in a discharge mode in which an oxygen-free oxidant from a cathode oxidizes a first composition of a base metal of an anode into reaction products in an electrolyte, separating an oxidation product of the base metal from one or more components of the reaction products in the electrolyte, and operating an electrolysis cell in an electrolysis mode in which the oxidation product of the base metal separated from the one or more components of the reaction products reduces to a second composition of the base metal, the second composition having a greater weight percentage of the base metal as compared to the first composition.

In some implementations, the base metal may be aluminum, magnesium, or titanium.

In certain implementations, the oxygen-free oxidant may include chlorine, fluorine, bromine, iodine, or a combination thereof, and the oxidation product of the base metal is a metal halide.

In some implementations, the oxygen-free oxidant may include sulfur, and the oxidation product of the base metal is a metal sulfide.

In certain implementations, the first composition of the base metal may include greater than about 80 weight percent of the base metal. For example, the second composition of the base metal may include at least about 99.5 weight percent of the base metal.

In some implementations, the reaction products may be carbon dioxide-free.

In certain implementations, operating the discharge cell in the discharge mode may include generating electrical power at the discharge cell. For example, operating the electrolysis cell in the electrolysis mode may include receiving electrical power generated by operating the discharge cell in the discharge mode. Additionally, or alternatively, operating the discharge cell in the discharge mode may generate at least 4 kWh of electrical energy per kilogram of the base metal in the first composition of the base metal. Further, or instead, operating the discharge cell in the discharge mode may include continuously generating power at rated power of the discharge cell for at least 10 hours.

In some implementations, operating the discharge cell in the discharge mode may include introducing the oxygen-free oxidant in a gaseous form into the electrolyte. For example, introducing the oxygen-free oxidant in the gaseous form into the electrolyte may include moving the oxygen-free oxidant into the electrolyte via a gas diffusion electrode of the discharge cell. Further, or instead, introducing the oxygen-free oxidant in the gaseous form into the electrolyte may include sparging the gaseous form of the oxygen-free oxidant into the electrolyte.

In certain implementations, operating the discharge cell in the discharge mode may include introducing the oxygen-free oxidant in a liquid form into the electrolyte.

In some implementations, the one or more components of the reaction products may include respective oxidation products of impurities of the first composition of the base metal, and the one or more components of the reaction products include oxidation products of the impurities of the first composition of the base metal. Examples of the impurities of the first composition of the base metal include silicon, lead, iron, zinc, copper, manganese, magnesium, or combinations thereof. In some instances, separating the oxidation product of the base metal from the one or more components of the reaction products in the electrolyte may include distilling the one or more components of the reaction products from the electrolyte. For example, distilling the oxidation product of the base metal from the one or more components of the reaction products in the electrolyte may include collecting vapor of the one or more components of the reaction products having a lower boiling temperature than the oxidation product of the base metal. Further, or instead, distilling the one or more components of the reaction products from the electrolyte may include collecting vapor of the one or more components of the reaction products separated from the electrolyte.

In certain implementations, the electrolyte may include a molten salt eutectic. The molten salt eutectic may have a eutectic temperature less than a melting point of the first composition of the base metal in the anode. In some instances, the first composition of the base metal of the anode may have a first density, the electrolyte has a second density, the oxygen-free oxidant from the cathode has a third density, the first density is greater than the second density at a temperature below the eutectic temperature of the molten salt, and the second density is greater than the third density at the temperature below the eutectic temperature of the molten salt. Further, or instead, operating the discharge cell in the discharge mode may include intermittently operating the discharge cell in the discharge mode. As an example, intermittently operating the discharge cell in the discharge mode may include restarting the discharge cell from a temperature above the eutectic temperature of the molten salt eutectic and below the melting point of the first composition of the base metal in the anode. Further, or instead, operating the electrolysis cell in the electrolysis mode may include intermittently operating the electrolysis cell in the electrolysis mode. As an example, intermittently operating the electrolysis cell in the electrolysis mode may include heating the electrolysis cell with heat transfer from the molten salt eutectic.

In some implementations, operating the discharge cell in the discharge mode may include operating the discharge cell with the first composition of the base metal in a molten state in the anode.

In certain implementations, operating the discharge cell in the discharge mode may include operating the discharge cell with the first composition of the base metal in a solid state in the anode. In some instances, operating the discharge cell in the discharge mode may include forming the first composition of the base metal in the solid state with a void volume ranging from 1 volume percent to 80 volume percent. As an example, forming the first composition of the base metal in the solid state with the void volume ranging from 1 volume percent to 80 volume percent may include one or more of crushing, shredding, melting, grinding, or pressing the first composition of the base metal into a shape of the anode.

In some implementations, the oxidation product of the base metal may be separated from the one or more components of the reaction products along a flow path in fluid communication between the discharge cell and the electrolysis cell.

In certain implementations, operating the electrolysis cell in the electrolysis mode may include forming the second composition of the base metal in a molten state and casting the molten state into a solid state of the second composition of the base metal. For example, the solid state of the second composition of the base metal may have a void volume less than 5 vol. percent.

In some implementations, operating the electrolysis cell in the electrolysis mode may include forming the second composition of the base metal as a solid in the electrolysis cell.

In certain implementations, operating the electrolysis cell in the electrolysis mode may produce the oxygen-free oxidant in a vapor phase. In some instances, operating the electrolysis cell in the electrolysis mode may include preheating the oxidation product of the base metal entering the electrolysis cell via heat transfer from the oxygen-free oxidant in the vapor phase produced by the electrolysis cell. Further, or instead, operating the electrolysis cell in the electrolysis mode may include flowing the oxygen-free oxidant in the vapor phase, produced by the electrolysis cell, to the discharge cell via a return circuit in fluid communication between the electrolysis cell and the discharge cell. For example, operating the discharge cell in the discharge mode may include flowing a make-up volume of the oxygen-free oxidant into the discharge cell.

In some implementations, wherein the discharge cell and the electrolysis cell may be the same electrochemical reactor.

According to another aspect, a system for purifying metal-containing material may include a discharge cell including an anode, a cathode, and an electrolyte in ionic communication therebetween, the anode including a first composition of a base metal, and the electrolyte including an oxygen-free oxidant, a distillation module in fluid communication with the electrolyte from the discharge cell and, in the distillation module, an oxidation product of the base metal separable from one or more reaction products in the electrolyte, and an electrolysis cell in fluid communication with the oxidation product of the base metal separated by the distillation module, the electrolysis cell operable to reduce the oxidation product of the base metal to the oxygen-free oxidant and a second composition of the base metal.

In certain implementations, operation of the electrolysis cell in an electrolysis mode may be at least partially powered by electrical power generated by operation of the discharge cell in a discharge mode.

In some implementations, the electrolyte may include a molten salt. The molten salt may have a eutectic temperature less than a melting temperature of the base metal. For example, the electrolyte may have a melt temperature less than 300° C. Further, or instead, the molten salt may have a eutectic temperature greater than 400° C. and less than 500° C. Additionally, or alternatively, the first composition of the base metal of the anode may have a first density, the oxygen-free oxidant from the cathode has a second density, and the first density is greater than the second density at a temperature below a eutectic temperature of the molten salt electrolyte. Still further, or instead, the electrolyte may have a conductivity of about 0.25 S/cm to about 0.35 S/cm. In some instances, the electrolyte may include a molten chloride eutectic. For example, the electrolyte may include an alkali chloride, an alkaline chloride, the oxidation product of the base metal, or a combination thereof. In certain instances, the molten chloride eutectic may include sodium chloride (NaCl), potassium chloride (KCl), magnesium chloride (MgCl2), aluminum chloride (AlCl3), lithium chloride (LiCl), or a combination thereof. In some instances, the system may further include a reservoir of the molten salt eutectic and a pump, wherein the electrolysis cell includes a first insulation jacket in thermal communication with one or more electrodes of the electrolysis cell, the reservoir of the molten salt eutectic is in fluid communication with the jacket via the pump, and the pump is controllable to circulate the molten salt eutectic between the reservoir and the first insulation jacket to maintain a target temperature of the electrolysis cell.

In certain implementations, the electrolysis cell may include a second insulation jacket in thermal communication with the anode, the cathode, and the electrolyte, and the one or more reaction products separated from the oxidation product of the base metal are controllably flowable through the second insulation jacket to maintain a target temperature of the electrolysis cell between electrolysis cycles.

In some implementations, the system may further include an insulation shield removably securable about the electrolysis cell between electrolysis cycles of the electrolysis cell.

In certain implementations, the system may further include a first heat exchanger in thermal communication between an outlet of the electrolysis cell and an inlet of the electrolysis cell, wherein heat from the oxygen-free oxidant exiting the outlet of the electrolysis cell is transferrable, via the first heat exchanger, to the oxidation product of the base metal, separated by the distillation module, entering the inlet of the electrolysis cell.

In some implementations, the system may further include a second heat exchanger in thermal communication between an outlet of the discharge cell and an inlet of the discharge cell, wherein heat from the oxidation product of the base metal separated by the distillation module is transferrable, via the second heat exchanger to the oxygen-free oxidant entering the inlet of the discharge cell. As an example, the second heat exchanger may include a thermal exchange liquid, the thermal exchange liquid solvates the oxidation product of the base metal at a temperature lower than an evaporation temperature of the thermal exchange liquid, and the thermal exchange liquid is heatable to re-release the oxidation product of the base metal moving into the electrolysis cell.

In certain implementations, in the anode, the first composition of the base metal may be porous. For example, the first composition of the base metal in the anode may have a void volume greater than or equal to 1 volume percent and less than or equal to 80 volume percent.

In some implementations, the anode may have an area-specific resistance of greater than about 0.75 Ω/cm² and less than about 1.25 Ω/cm².

In certain implementations, the anode and the cathode of the discharge cell may define a gap of greater than 3 mm and less than 10 mm.

In some implementations, the system may further include a return circuit in fluid communication between the electrolysis cell and the discharge cell, wherein the oxygen-free oxidant is flowable from the electrolysis cell to the discharge cell via the return circuit.

In certain implementations, the cathode may include a catalyst effective to reduce the oxygen-free oxidant to ions of the oxygen-free oxidant. For example, the catalyst may include carbon, a metal, or a combination thereof. Additionally, or alternatively, the catalyst may include a metal oxide (e.g., ruthenium oxide, titanium oxide, or a combination thereof).

In some implementations, the oxygen-free oxidant may be introducible into the electrolyte in a gaseous state. For example, the cathode may be porous. Further, or instead, the cathode may be a gas diffusion electrode. Still further, or instead, the cathode may include a sparger.

In certain implementations, the oxygen-free oxidant may be introducible into the electrolyte in a liquid state. For example, the cathode may include a liquid flow field.

According to yet another aspect, an electrochemical cell with a thermal gradient may include an anode including a base metal, a cathode, an electrolyte including a molten salt, a vessel in which the anode, the cathode, and the electrolyte are disposed with the anode and the cathode in ionic communication with one another via the electrolyte, the vessel defining a headspace above the anode, and the vessel defining a vapor discharge outlet in fluid communication with the headspace, a heat exchanger in thermal communication with the anode, a heating system adapted to control (i) a temperature of a volatile species of the molten salt electrolyte in the headspace adjacent the vapor discharge outlet of the vessel, and (ii) a temperature of reaction products, comprising an oxidation product of the base metal, at the vapor discharge outlet, and a controller adapted to control the heat exchanger and the heating system whereby the electrolyte is maintained at a first temperature T1, walls of the vessel defining the headspace are maintained at a second temperature T2, and the reaction products comprising, comprising the oxidation product of the base metal, at the vapor discharge outlet are maintained at a third temperature T3 at or above a bubble temperature of oxidation product of the base metal. In some implementations, the relationship between T1, T2, and T3 may be T1<T3<T2.

In certain implementations, the oxidation product of the base metal may be a halide.

In some implementations, the base metal may be aluminum.

In certain implementations, the anode may be adapted for continuously feeding consumable base metal into the electrochemical cell. For example, the consumable base metal may have a porosity of between 25% and 70%, based on a total volume of the consumable base metal.

In certain implementations, the oxidation product of the base metal is a chloride of the base metal and T1 is 110° C. to 175° C., T2 is 120° C. to 200° C. and T3 is 150° C. to 190° C.

In some implementations, the oxidation product of the base metal may be a chloride of the base metal and T1 is 150° C., T2 is 150° C. to 179° C. and T3 is 180° C.

In certain implementations, the electrochemical cell may be a bipolar electrode reactor.

In some implementations, the cathode may be a gas diffusion electrode.

In certain implementations, the cathode may be submerged in the electrolyte.

In some implementations, the vessel may define a slag outlet.

According to still another aspect, an electrochemical cell for semi-continuous operation may include a cathode, an anode including a base metal, an electrolyte including a molten salt, and a vessel defining an electrolyte chamber, an electrolyte inlet, and an electrolyte outlet, the electrolyte disposed in the electrolyte chamber, the base metal of the anode semi-continuously feedable into contact with the electrolyte in the electrolyte chamber, the cathode in ionic communication with the base metal of the anode via the electrolyte in the electrolyte chamber, the base metal of the anode is oxidizable by an oxygen-free oxidant from the cathode to form reaction products in the electrolyte in the chamber, the electrolyte is movable into the electrolyte chamber via the electrolyte inlet, and a stream of the electrolyte containing the reaction products is movable out of the electrolyte chamber via the outlet.

In some implementations, the base metal of the anode may be in the form of a strip feedable into contact with the electrolyte in the electrolyte chamber. For example, a surplus of the strip may be removable from the electrolyte via a take-up roll.

In certain implementations, the anode may include a current collector and a piston, the current collector mesh and the piston defining a feed compartment therebetween, the piston movable toward the current collector mesh such that the base metal moves into the electrolyte in the electrolyte chamber via the current collector.

In some implementations, the anode may include a current collector, the anode defines a feed port in fluid communication with the current collector, the base metal is feedable into the current collector via the feed port, and the base metal in the current collector is feedable into the electrolyte in the chamber via the current collector.

In certain implementations, the base metal of the anode may include a body drawn into the electrolyte in the electrolyte chamber from a molten source of the base metal.

In some implementations, the base metal of the anode may include a slurry feedable through a current collector in the electrolyte chamber.

In certain implementations, the stream of the electrolyte containing the reaction products may be a eutectic comprising aluminum chloride (AlCl3), sodium chloride (NaCl), and potassium chloride (KCl). As an example, the base metal may be aluminum, the oxygen-free oxidant is chlorine and the electrolyte containing the reaction products includes 40 to 70 weight percent aluminum chloride, 15 to 30 weight percent sodium chloride, and 15 to 30 weight percent potassium chloride, based on a total weight of the electrolyte containing the reaction products. Further, or instead, the electrolyte containing the reaction products may further include up to 15 weight percent lithium chloride (LiCl) based upon a total weight of the electrolyte. Additionally, or alternatively, the electrolyte containing the reaction products may further include: a) at least one cation selected from Mg2+, Ca2+, ammonium, pyrrolidinium, pyridinium, pyrimidinium, imidazolium, piperidinium, pyrazolium, oxazolium, pyridazinium, phosphonium, sulfonium, triazolium, or a combination thereof; and b) at least one anion of BF4−, PF6−, AsF6−, SbF6−, AlCl4−, HSO4−, Cl04−, CH3SO3−, CF3CO2−, Cl−, Br−, I−, SO4−, CF3SO3−, (FSO2)2N−, (C2F5SO2)2N−, (C2F5SO2)(CF3 SO2) N−, (CF3 SO2)2N−, or a combination thereof, preferably, N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, 1-ethyl-3-methylimidazolium bis(trifluoromethylsulfonyl)amide, or a combination thereof.

In some implementations, the electrochemical cell may further include an anion exchange membrane partitioning the electrolyte chamber into a cathode compartment holding the cathode and an anode compartment holding the anode.

In certain implementations, the cathode may be a gas diffusion electrode including a gas flow field.

In some implementations, the electrochemical cell may further include a gas sparger adjacent the cathode, wherein a gaseous form of the oxygen-free oxidant is movable, via the gas sparger, to a surface of the cathode submerged in the electrolyte in the electrolyte chamber.

In certain implementations, the cathode may define a first flow through chamber in which a gaseous form of the oxygen-free oxidant is flowable, the anode includes a porous metal defining at least a portion of a second flow through chamber, and a consumable form of the base metal is receivable into the second flow through chamber via the porous metal.

According to still another aspect, a method of mechanically rechargeable power generation may include operating a discharge cell in a discharge mode in which, in an electrolyte, an oxygen-free oxidant from a cathode oxidizes a base metal of an anode into an oxidation product of the base metal, deliver the oxidation product of the base metal from the discharge cell to an electrolysis cell, operating the electrolysis cell in an electrolysis mode in which the oxidation product of the base metal removed from the discharge cell reduces to the base metal and the oxygen-free oxidant, returning the base metal from the electrolysis cell to the anode of the discharge cell, and returning the oxygen-free oxidant from the electrolysis cell to the cathode of the discharge cell.

In certain implementations, the cathode may be a molten cathode, the oxidation product of the base metal formed by operating the discharge cell in the discharge mode adsorbs onto the molten cathode, and removing the oxidation product of the base metal from the discharge cell includes removing the oxidation product of the base metal from the molten cathode. For example, the oxygen-free oxidant may be sulfur, and the oxidation product is a sulfide.

In some implementations, the oxygen-free oxidant may be a gas, and removing the oxidation product of the base metal from the discharge cell includes moving the electrolyte from the discharge cell, and operating the electrolysis cell includes receiving one or more components of the electrolyte removed from the discharge cell as a feedstock into the electrolysis cell. For example, the gas may be chlorine gas, and the oxidation product of the base metal is a metal chloride. Further, or instead, the gas may be nitrogen gas, and the oxidation product of the base metal is a metal nitride.

In certain implementations, the electrolyte may include an inorganic eutectic.

In some implementations, the base metal may be aluminum, magnesium, or a combination thereof.

In certain implementations, delivering the oxidation product of the base metal from the discharge cell to the electrolysis cell may include storing the oxidation product of the base metal, and operating the electrolysis cell includes operating the electrolysis cell intermittently.

In some implementations, operating the discharge cell and operating the electrolysis cell may be co-located with one another. For example, operating the discharge cell in the discharge mode may produce power, and operating the electrolysis cell includes at least partially powering operation of the electrolysis cell using the power produced by operating the discharge cell in the discharge mode.

### BRIEF DESCRIPTION OF THE DRAWINGS

FIG. 1 is a schematic representation of a system for purifying metal-containing material, the system including a discharge cell, a distillation module, and an electrolysis cell.

FIGS. 2A-2D are schematic representations of discharge cells of the system of FIG. 1, showing different anode-cathode pairs and electrolytes.

FIG. 3 is a graph of vapor pressure versus temperature showing one possible operational regime for the current method of recovering oxidation product of a base metal, in this case, aluminum chloride, from the discharge cell of the system of FIG. 1.

FIG. 4 is a flowchart of an exemplary method of reversibly purifying metal-containing material.

FIG. 5 is a free energy diagram illustrating various aluminum conversion pathways, including both hard oxidation and soft oxidation routes.

FIG. 6 is a bar chart of net energy requirements for galvanic and electrolytic processes for aluminum production.

FIG. 7 is a schematic representation of an electrolysis cell including an insulation jacket in fluid communication with a reservoir of a molten salt.

FIG. 8 is a schematic representation of a discharge cell including a heating system controllable to maintain a thermal gradient in the discharge cell.

FIG. 9 is a schematic representation of one possible thermal gradient maintainable in the discharge cell of the system of FIG. 7.

FIG. 10 is a schematic representation of a bipolar cell.

FIG. 11 is a schematic representation of a bipolar cell.

FIG. 12A is a schematic representation of a portion of a discharge cell including a gas diffusion cathode.

FIG. 12B is a schematic representation of a portion of a discharge cell including a cathode having a sparger.

FIG. 13A is a schematic representation of a portion of a discharge cell including a plug flow of a base metal into the discharge cell.

FIG. 13B is a schematic representation of a portion of a discharge cell including a reel feed of a base metal into the discharge cell.

FIG. 13C is a schematic representation of an anode including a feed compartment defined between a current collector and a piston.

FIG. 13D is a schematic representation of an anode including a feed compartment defined between a current collector and a piston, the anode defining a feed port in fluid communication with the current collector.

FIG. 13E is a schematic representation of an anode including a body of a base metal drawn into an electrolyte from a molten source of the base metal.

FIG. 14 is a schematic representation of a discharge cell including a cathode and an anode, the cathode defining a first flow through chamber and the anode defining a second flow through chamber.

FIG. 15 is a schematic representation of a heat exchanger in thermal communication between an inlet and an outlet of a discharge cell.

FIG. 16 is a block diagram of a system for power generation, the system including a discharge cell and an electrolysis cell, the discharge cell mechanically rechargeable by the electrolysis cell.

FIG. 17 is a flowchart of an exemplary method of mechanically rechargeable power generation.

Like reference symbols in the various drawings indicate like elements.

### DETAILED DESCRIPTION

Embodiments will now be described more fully hereinafter with reference to the accompanying figures, in which exemplary embodiments are shown. The foregoing may, however, be embodied in many different forms and should not be construed as limited to the exemplary embodiments set forth herein. All materials (e.g., solids, liquids, gases, or combinations thereof) may flow through conduits (e.g., pipes and/or manifolds) unless specified otherwise or made clear from the context.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

As used herein, unless otherwise stated or made clear from the context, the term “discharge cell” shall be understood to include any one or more of the various different electrochemical cells described herein operating in a discharge mode in which net electrical power and heat is generated by the discharge cell. Further, or instead, unless otherwise stated or made clear from the context, the term “electrolysis cell” shall be understood to include any one or more of the various different electrochemical cells described herein operating in an electrolysis mode requiring electrical power. Thus, unless a contrary intention is indicated, it shall be understood that the discharge cell and the electrolysis cell may be identical, or at least similar, electrochemical cells operating in different (reverse) modes. Further, or instead, to the extent systems are described herein as including a discharge cell and an electrolysis cell, it shall be understood that the discharge cell and the electrolysis cell may be the same instance of an electrochemical cell. Accordingly, for the sake of clear and efficient description, various aspects of the discharge cell are described in detail, and it shall be understood that the electrolysis cell may include any one or more of the features of any one or more of the discharge cells described herein. For example, the discharge cell and the electrolysis cell may use the same electrolyte.

In the disclosure that follows, certain aspects of systems, devices, and methods are described with respect to aluminum as a base metal and chlorine as an oxygen-free oxidant, as these materials are ubiquitous and represent a cost-effective end use. It shall be appreciated, however, that the focus on aluminum-chlorine combinations is for the sake of clear and efficient description and shall not be understood to be limiting, unless otherwise stated or made clear from the context. Thus, as described in greater detail below, the base metal may include any one or more of aluminum, magnesium, titanium, or any other light metal and, further or instead, the oxygen-free oxidant may include chlorine, fluorine, bromine, iodine, sulfur, or any combination thereof.

As used herein, unless otherwise specified or made clear from the context, the term “composition of a base metal” and variations thereof, shall be understood to include the base metal in combination with one or more additional elements. For the sake of clear and efficient description, the present disclosure focuses on compositions of the base metal including some impurities (e.g., tramp elements). However, unless another intent is explicitly stated or clear from the context, compositions of the base metal may include an alloy of the base metal. Further for the sake of clear description and reducing repetitiveness, it shall be understood that the first composition of the base metal may include low-quality aluminum (e.g., any one or more forms of scrap aluminum) that may be purified into a more commercially valuable form having higher weight percentage of aluminum.

For the sake of clear and efficient description, elements with numbers having the same last two digits in the disclosure that follows shall be understood to be analogous to or interchangeable with one another, unless otherwise explicitly made clear from the context. Accordingly, elements with numbers having the same last two digits in the disclosure that follows are not described separately from one another, except to note differences or to emphasize certain features. Thus, for example, a discharge cell 101 and a discharge cell 1101 shall be understood to be analogous to or interchangeable with one another, unless otherwise specified or made clear from the context.

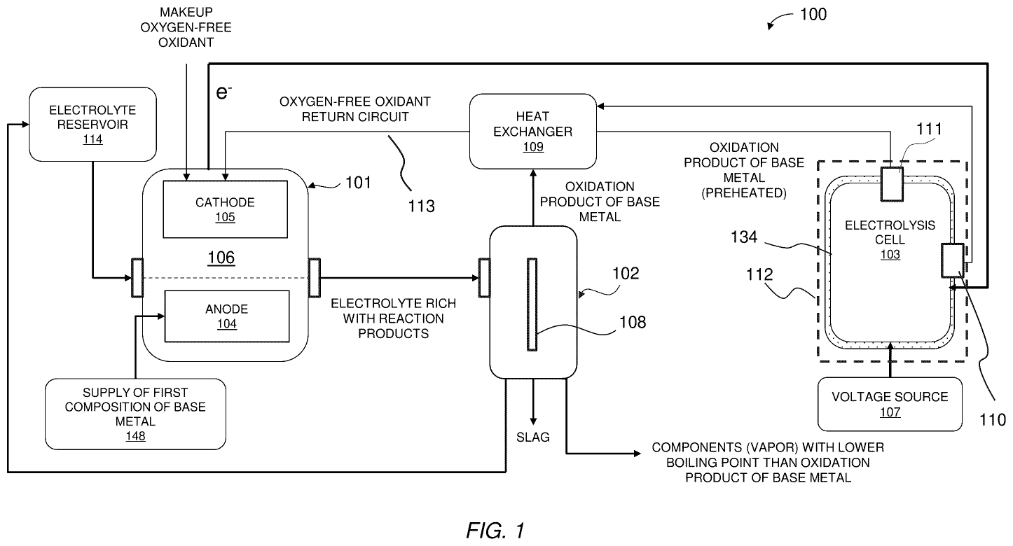

Referring now to FIG. 1, a system 100 system for purifying metal-containing material may include a discharge cell 101, a distillation module 102, and an electrolysis cell 103. The discharge cell 101 may include an anode 104, a cathode 105, and an electrolyte 106 in ionic communication therebetween (e.g., in a gap greater than 3 mm and less than 10 mm). The anode 104 may include a first composition of a base metal and, further or instead, the electrolyte 106 may include an oxygen-free oxidant. The distillation module 102 may be in fluid communication with the electrolyte 106 from the discharge cell 101. In the distillation module 102, as described in greater detail below, an oxidation product of the base metal may be separable from one or more reaction products in the electrolyte 106. The electrolysis cell 103 may be in fluid communication with the oxidation product of the base metal separated by the distillation module 102, and the electrolysis cell 103 may be operable to reduce the oxidation product of the base metal to the oxygen-free oxidant and a second composition of the base metal. The second composition of the base metal may have a greater weight percentage of the base metal as compared to the first composition of the base metal—that is, the second composition of the base metal may be purified relative to the first composition of the base metal.

As described in greater detail below, as compared to other galvanic and electrochemical processes for recycling the base metal such as the Hall-Héroult process or the use of a metal-air electrochemical cell, the system 100 may facilitate forming high-quality base metal using less energy—through improved roundtrip efficiency—and, thus, generally at a lower cost and with fewer greenhouse gas emissions. For example, operation of the electrolysis cell 103 in the electrolysis mode may be at least partially powered by electrical power generated by electrons released at the anode 104 and flowing through an external circuit (e.g., the oxidation reaction may proceed at open circuit voltages in the range of 2 to 3 volts, depending on the metal-oxidant pair), thus reducing external power required from a voltage source 107 for operating the electrolysis cell 103 in the electrolysis mode. Further or instead, the system 100 may be operated intermittently, such as may be useful for generating high-quality base metal using low-cost energy sources, such as wind, solar, hydro, or other renewables. Still further, or instead, the system 100 may produce intermediate products that may be valorized in addition or as an alternative to forming high-quality base metal. For example, in instances in which the first composition of the base metal is scrap-grade aluminum and the oxygen-free oxidant is a halide, the system 100 may produce aluminum chloride (AlCl₃) as well as chlorides of impurities present in the first composition of the base metal (e.g., silicon chloride, iron chloride, zinc chloride, copper chloride, manganese chloride, and/or magnesium chloride). All or a portion of the aluminum chloride (AlCl₃) may be sold as a final product and/or may be further processed into higher purity aluminum according to any one or more of the various different techniques described herein while the chlorides of the impurities may also be sold as end products.

In general, the anode 104 may include the first composition of the base metal in any form that may be compatible with operation of the discharge cell 101. For example, the first composition of the base metal in the anode 104 may be solid or molten. Further, or instead, the first composition of the base metal in the anode 104 may have porosity and/or density within a predetermined range for achieving target discharge performance of the discharge cell 101.

The base metal may include aluminum, magnesium, titanium, or a combination thereof. Further, or instead, the first composition of the base metal may be sourced from scrap (e.g., scrap aluminum), which may be ubiquitously and cost-effectively sourced in various geographic locations. In certain instances, scrap materials that would otherwise not be recycled may be recycled according to the techniques described herein. For aluminum, examples include foil, architectural sheet, Zorba, and twitch, which can represent a variety of compositions and gauges. Metal scrap used to form the first composition of the base metal in the anode 104 may be decoated to remove any organic material. The particle sizes and forms (e.g., briquettes) of such scrap in the anode 104 may be controlled to reduce the costs and energy usage to form porous form factors of the first composition of the base metal in the anode 104.

In certain instances, the anode 104 may be porous to facilitate lower over-potentials and reduce the risk of passivation of the surface of the anode 104. The density of the first composition of the base metal of the anode 104 has an impact both on the achievable discharge capacity as well as capacity retention. It is expected that the contaminant metals in the first composition of the base metal may be stripped into the electrolyte 106 and any non-soluble species may accumulate as a slag, which may be removable from the discharge cell 101 in some implementations. The density and surface area of the first composition of the base metal in the anode 104 may be selected to allow for high utilization of the anode material at high areal current densities while tolerating the presence of contaminants in the first composition of the base metal in the anode 104. As a specific example, the first composition of the base metal in the anode 104 may have a void volume greater than or equal to 1 volume percent and less than or equal to 80 volume percent. Further, or instead, the anode 104 may have an area-specific resistance of greater than about 0.75 Ω/cm² and less than about 1.25 Ω/cm².

In general, the cathode 105 may be any one or more of various different materials and/or include any one or more of various different form factors through which an oxygen-free oxidant (e.g., chlorine, fluorine, bromine, iodine, or sulfur) may be introduced in gaseous or liquid form such that ions of the oxygen-free oxidant may be introduced into the electrolyte 106 via the cathode 105. Further, or instead, the cathode 105 may include any one or more of various different materials. In certain instances, the cathode 105 may include a gas reduction electrode, which may facilitate achieving better performance and/or improved long-term stability relative to relying only on a gas of the oxygen-free oxidant. For example, the cathode 105 may include one or more catalysts that facilitate reduction of the oxygen-free oxidant to ions of the oxidant-free oxidant. As a specific example, in instances in which the oxygen-free oxidant includes chlorine, the catalyst may include carbon (e.g., vitreous carbon), metal, a metal oxide (e.g., ruthenium oxide and/or titanium oxide), or a combination thereof. Additional or alternative aspects of the cathode 105 are described in greater detail below.

In general, the electrolyte 106 may facilitate electrochemical dissolution of the first composition of the base metal of the anode 104 into the electrolyte 106 and selective recovery of the oxidation product of the base metal from the electrolyte 106. In certain instances, electrolyte 106 may have a conductivity of about 0.25 S/cm to about 0.35 S/cm. Further, or instead, the electrolyte 106 may include a mixed salt, for example a solid having a melting temperature below 300° C. In particular, the electrolyte 106 may include a eutectic mixture having a melting temperature below 300° C., for example, 50° C. to 280° C. Examples of the electrolyte 106 include (i) an alkali halide, an alkaline halide, or a combination thereof, and (ii) a metal chloride where the metal is the base metal of the anode 104. As a specific example, the electrolyte 106 may include a eutectic mixture of an alkali chloride and aluminum chloride and, optionally, an alkaline chloride. In certain implementations, the electrolyte 106 may include a binary NaCl—KCl (T_{eutectic}=657° C.) system with the addition of aluminum chloride (AlCl₃) to reduce its melting temperatures below 300° C. (e.g., AlCl3-NaCl—KCl (50-36-14 mol %, Tₘ=132° C.).

In certain instances, the electrolyte 106 may have a low-melting temperature and may be highly conductive (>20 mA/cm2), as may be useful for achieving rapid dissolution of the first composition of the base metal of the anode 104 by controlling the overpotentials over a range of applied currents and by characterizing resistances from ohmic, charge-transfer, and mass-transport mechanisms at 100-300° C. As described in greater detail below, composition of the electrolyte 106 may be rich in reaction products following dissolution of the first composition of the base metal in the electrolyte 106 in the discharge cell 101 and may be subjected to thermal distillation (100-300° C.) and/or other separation processes to recover the oxidation product of the base metal for introduction into the electrolysis cell 103.

In certain instances, dissolution kinetics of the first composition of the base metal of the anode 104 may be determined by applying various current densities to establish current-potential (I-E) relationship at 100-300° C. For example, a three-electrode cell may be constructed for accurate description of electrochemical performance employing the first composition of the base metal as the anode, a pure form of the base metal as a reference electrode, and graphite as the cathode. Electrolysis experiments (e.g., 1-3 h) may be performed to determine the effect of salt chemistry of the electrolyte 106 on the dissolution of the first composition of the base metal. After the tests are completed, the three-electrode cell may be disassembled, and the product quality may be characterized using electron microscopy, and coulombic efficiency can be evaluated. Residual anode product (anode slime) and electrolyte compositions can be characterized by inductively-coupled plasma mass spectroscopy (ICP-MS). Despite the base metal of the anode 104 being a dominant electroactive species to dissolve into the electrolyte 106, alloying elements and/or impurities in the first composition of the base metal (e.g., Mg, Cu, Si) may co-dissolve into the electrolyte 106, especially when the dissolution reactions occur at high currents (or overpotentials). Therefore, it may be beneficial to evaluate the potentials at which these contaminants dissolve in the electrolyte 106 and the effect of these reaction products (MgCl2, CuCl₂, SiCl₄, in the case of chlorine as the oxygen-free oxidant) on the properties of the electrolyte 106, including the melting temperature and solubility by DSC measurements. In addition, the I-E relationship of the base metal in the electrolyte 106 may be determined in complement with electrochemical impedance spectroscopy (EIS). These measurements may quantify the impact of contaminants on processes in the discharge cell 101 based on the changes in ohmic, charge-transfer, and mass-transport resistances compared to a pristine instance of the electrolyte 106. Quantification and other understanding of the factors leading to stranded discharge products and the sensitivity of the anode 104 to changes in composition of the electrolyte 106 during dissolution may facilitate achieving utilization of 80% or greater.

In some implementations, the electrolyte 106 may include a molten salt to facilitate ion transport and electrochemical oxidation of the base metal to form the oxidation product of the base metal. The molten salt may, for example, have a eutectic temperature less than a melting temperature of the base metal of the anode 104 such that the base metal of the anode 104 solidifies before the electrolyte 106 solidifies and, thus, the discharge cell 101 may be operable at a lower temperature and may be less likely to short when brought down to a temperature at which the electrolyte 106 freezes (e.g., at less than 300° C.), as compared to an electrochemical cell in which an electrolyte freezes at a higher temperature than a base metal of an anode. As a specific example, the molten salt may have a eutectic temperature greater than 400° C. and less than 500° C., as may be useful in instances in which the base metal is aluminum or another light metal with a melting temperature above this range.

In certain implementations, for the production of a chloride of the base metal (e.g., aluminum chloride), the molten salt of the electrolyte 106 may include alkali chloride, an alkaline chloride, the oxidation product of the base metal, or a combination thereof. For example, the electrolyte 106 may include a molten chloride eutectic comprising aluminum chloride (AlCl₃), sodium chloride (NaCl), and potassium chloride (KCl). The molten chloride eutectic may comprise 40 to 70 weight percent (wt %) aluminum chloride, 15 to 30 wt % sodium chloride, and 15 to 30 wt % potassium chloride, based on a total weight of the molten chloride eutectic. The content of aluminum chloride may be 40, 45, or 50 to 60, 65, or 70 wt % aluminum chloride in the molten salt, based on a total weight of the molten chloride eutectic. The content of sodium chloride may be 15, 17, or 20 to 25, 28, or 30 wt % sodium chloride, based on a total weight of the molten chloride eutectic. The content of potassium chloride may be 15, 17, or 20 to 25, 28, or 30 wt % potassium chloride, based on a total weight of the molten salt. The molten salt may also, or instead, include other salts such as lithium chloride (LiCl) and/or magnesium chloride (MgCl₂), in an amount of up to 15 wt %, such as 0.1, 1, 2, or 5 to 10, 12, 14, or 15 wt %, based on a total weight of the molten chloride eutectic. The endpoints of all ranges are independently combinable.

In certain implementations, for the production of a bromide of the base metal (e.g., aluminum bromide), the electrolyte 106 may include a molten bromide eutectic comprising aluminum bromide, sodium bromide, potassium bromide, lithium bromide, or a combination thereof. The molten bromide eutectic may include 40 to 70 weight percent (wt %) aluminum bromide, 15 to 30 wt % sodium bromide, and 15 to 30 wt % potassium bromide, based on a total weight of the molten bromide eutectic. The content of aluminum bromide may be 40, 45, or 50 to 60, 65, or 70 wt % aluminum bromide, based on a total weight of the molten bromide eutectic. The content of sodium bromide may be 15, 17, or 20 to 25, 28, or 30 wt % sodium bromide, based on a total weight of the molten bromide eutectic. The content of potassium bromide may be 15, 17, or 20 to 25, 28, or 30 wt % potassium bromide, based on a total weight of the molten bromide eutectic. The molten salt may also include other salts such as lithium bromide, in an amount of up to 15 wt %, such as 0.1, 1, 2, or 5 to 10, 12, 14, or 15 wt %, based on a total weight of the molten bromide eutectic. The endpoints of all ranges are independently combinable.

In some implementations, the electrolyte 106 may include: a) at least one cation selected from Mg2+, Ca2+, ammonium, pyrrolidinium, pyridinium, pyrimidinium, imidazolium, piperidinium, pyrazolium, oxazolium, pyridazinium, phosphonium, sulfonium, triazolium, or a combination thereof; and b) at least one anion of BF4−, PF6−, AsF6−, SbF6−, AlCl4−, HSO4−, ClO4−, CH3SO3−, CF3CO2−, Cl−, Br−, I−, SO4−, CF3SO3−, (FSO2)2N−, (C2F5SO2)2N−, (C2F5SO2)(CF3SO2)N−, (CF3SO2)2N−, or a combination thereof. The ionic liquid may be, for example, N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, 1-ethyl-3-methylimidazolium bis(trifluoromethylsulfonyl)amide, or a combination thereof.

The polymer ionic liquid may contain a repeating unit including: a) at least one cation of N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)imide, 1-ethyl-3-methylimidazolium bis(trifluoromethylsulfonyl)amide, or a mixture thereof; and b) at least one anion of BF4−, PF6−, AsF6−, SbF6−, AlCl4−, HSO4−, ClO4−, CH3SO3−, CF3CO2−, (CF3SO2)2N−, (FSO2)2N−, Cl−, Br−, I−, SO4−, CF3SO3−, (C2F5SO2)2N−, (C2F5SO2)(CF3SO2)N−, NO3−, Al2Cl7−, (CF3SO2)3C, (CF3)2PF4−, (CF3)3PF3−, (CF3)4PF2−, (CF3)5PF−, (CF3)6P−, SF5CF2SO3−, SF5CHFCF2SO3−, CF3CF2(CF3)2CO−, CF3SO2)2CH−, (SF5)3C−, (O(CF3)2C2(CF3)2O)2PO−, or a combination thereof. In one particularly useful embodiment, the electrolyte 106 may include 1-ethyl-3-methylimidazolium chloride or aluminum chloride containing ethyl n-propyl sulfone.

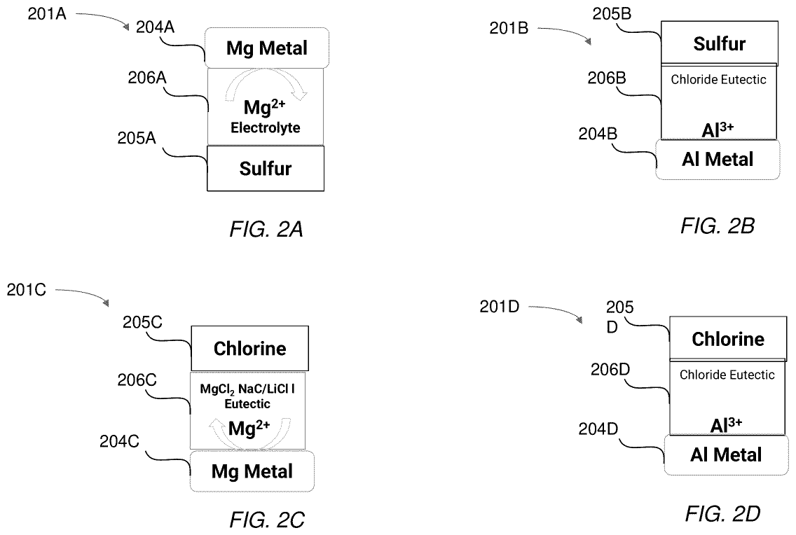

Referring now to FIG. 1 and FIGS. 2-D and returning to the discussion of the eutectic temperature of the electrolyte 106 relative to the freezing temperature of the base metal of the anode 104, it shall be additionally appreciated that density of the electrolyte 106 relative being between the respective densities of the first composition of the base metal of the anode 104 and the cathode 105 may limit or even prevent failure modes associated with unintentional inversion of the discharge cell 101 in the event that temperature of the discharge cell 101 falls below the eutectic temperature of the electrolyte 106 such that the discharge cell 101 freezes. In particular, the first composition of the base metal of the anode 104 may have a first density, the electrolyte 106 may have a second density, and the oxygen-free oxidant from the cathode 105 may have a third density at a temperature below the eutectic temperature of the molten salt of the electrolyte 106, and the second density of the electrolyte 106 may be between the first density and the second density at such a temperature. Such relative densities may make the discharge cell 101 resistant to inversion at low temperatures, thus allowing the discharge cell 101 to continue performing after cycling between freezing conditions and operating conditions. Stated differently, the resistance to inversion facilitated by the relative densities of the electrolyte 106, the oxygen-free oxidant from the cathode 105, and the first composition of the base metal of the anode 104 may facilitate using the system 100 in combination with an intermittent energy source, such as renewable energy sources.

Referring now to FIG. 1 and FIG. 2A, a discharge cell 201A includes magnesium-sulfur (Mg—S) chemistry. An anode 204A of the discharge cell 201A includes a metallic magnesium, and an electrolyte 206A. A cathode 205A of the discharge cell 201A accepts sulfur species as the oxygen-free oxidant during discharge operation of the discharge cell 201A. The electrolyte 206A operates at a temperature above the melting point of elemental sulfur, typically exceeding 110° C. The relative densities of the metallic magnesium of the anode 204A and the electrolyte 206A are shown schematically, with the metallic magnesium of the anode 204A shown floating on the electrolyte 206A. However, as operating temperature of the discharge cell 201A increases above 110° C. and below the melting temperature of magnesium (650° C.), the density of the molten sulfur may become greater than density of the anode 204A, and the positions of the anode 204A and the cathode 205A may become inverted, leading to shorting and requiring the discharge cell 201A to be destroyed and restarted.

Referring now to FIG. 1 and FIG. 2B, a discharge cell 201B includes aluminum-sulfur (Al—S) chemistry. An anode 204B of the discharge cell 201B includes aluminum. An electrolyte 206B of the discharge cell 201B includes molten sulfur between the anode 204B and a cathode 205B. During discharge operation of the discharge cell 201B, the cathode 205B accepts sulfur species as the oxygen-free oxidant. The discharge cell 201B operates in a temperature range of approximately 110° C. to 200° C. Due to the higher density of aluminum (approximately 2.7 g/cm³) compared to the density of sulfur below 110° C., the anode 204B is schematically shown in a lower position relative to the electrolyte 206B. As operating temperature of the discharge cell 201B increases above 110° C. to 200° C., the density of the molten sulfur of the cathode 205B decreases, remaining below density of the aluminum of the anode 204B. Thus, the discharge cell 201B does not undergo inversion as the discharge cell 201B freezes and unfreezes, making it robust with respect to the likelihood of inversion.

Referring now to FIG. 1 and FIG. 2C, a discharge cell 201C includes magnesium-chloride (Mg—Cl₂) chemistry. An anode 204C of the discharge cell 201C is magnesium, and an electrolyte 206C is a molten chloride salt, such as MgCl2, with a density of 1.45-1.55 g/cm³ in a temperature range from 650° C. to 850° C. A cathode 205C may be exposed to chlorine gas, allowing for the electrochemical formation of magnesium chloride. Due to the higher density of magnesium (approximately 1.73 g/cm³) compared to the density of the electrolyte 206C below 650° C., the anode 204C is schematically shown in a lower position relative to the electrolyte 206C. However, as temperature of the discharge cell 201C increases from 650° C. to 850° C., solid magnesium melts to become molten magnesium, which may have a lower than the density of the electrolyte 206C and inversion may occur.

Referring now to FIG. 1 and FIG. 2D, a discharge cell 201D includes aluminum-chloride (Al—Cl₂) chemistry. An anode 204D includes aluminum (density of 2.7 g/cm³), and electrolyte 206D includes a molten chloride eutectic. The discharge cell 201D operates in the approximate temperature range of 110° C. to 200° C., depending on the eutectic composition used. Due to the higher density of aluminum (approximately 1.73 g/cm³) compared to the density of the electrolyte 206D, the anode 204D is schematically shown in a lower position relative to the electrolyte 206D. The electrolyte 206D has a eutectic temperature less than a melting temperature of aluminum. Thus, the aluminum of the anode 204D solidifies before the electrolyte 206D freezes such that the density of the aluminum of the anode 204D remains greater than the density of the electrolyte 206D throughout increases and decreases in temperature, and inversion does not occur.

In general, the distillation module 102 may receive the electrolyte 106 rich in reaction products and separate the oxidation product of the base metal from other reaction products. For example, the electrolyte 106 received into the distillation module 102 from the discharge cell 101 may contain the oxidation product of the base metal and a range of oxidation products (e.g., halides) of various impurities in the first composition of the base metal of the anode 104.

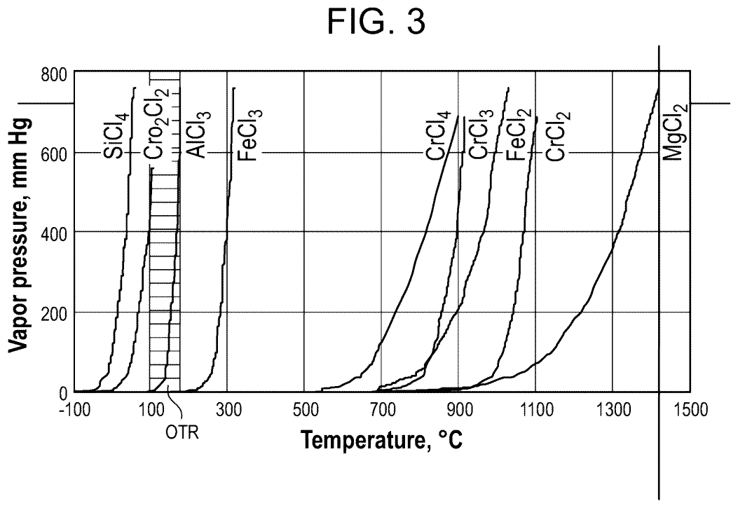

Referring now to FIG. 1 and FIG. 3, the distillation module 102 may separate the various species from one another based on respective boiling points and volatilities. This separation enhances the purity of the oxidation product of the base metal that is directed into the electrolysis cell 103 for reduction to the second composition of the base metal. Further, or instead, removal of reaction products from the electrolyte 106 moving from the discharge cell 102 toward the electrolysis cell 103 before the electrolyte 106 reaches the electrolysis cell 103 may facilitate maintaining consistent properties of the electrolyte 106 such that the electrolyte 106 may be used in the electrolysis cell 103 and/or may be recycled through the system 100, providing cost savings and facilitating continuous or semi-continuous operation of the system 100. As an example, high concentrations of iron chloride in the electrolyte 106 recycled into the discharge cell 101 may present a potential chemical shuttling mechanism in the discharge cell 101 and may reduce the faradaic efficiency of discharge. Additionally, or alternatively, accumulation of aluminum chloride in the electrolyte 106 may exceed the saturation limits, increasing the likelihood of passivating the anode 104. Further, or instead, separation of reaction products from the electrolyte 106 may facilitate achieving cost-effectiveness targets, given that certain reaction products (e.g., silicon chloride, aluminum chloride, iron chloride, zinc chloride, copper chloride, manganese chloride, and magnesium chloride) have separate commercial value apart from the base metal being purified by the system 100.

As compared to oxides, oxygen-free oxidants can form oxidation products having a wide range of boiling points, with few overlapping evaporations (as shown in FIG. 3 for chlorides). Accordingly, the distillation module 102 may operate at a temperature to separate/harvest the oxidation product of the base metal via distillation (e.g., fractional distillation), leveraging the large difference in boiling points and vapor pressure among volatile reaction products in the electrolyte 106 into the distillation module 102 from the discharge cell 101. For example, in the case of aluminum as the base metal and chloride as the oxygen-free oxidant, the distillation module 102 may operate at a temperature in which the gases are almost entirely silicon chloride and aluminum chloride and passed through a condenser 108 of the distillation module 102 such that the silicon chloride condenses, leaving only aluminum chloride as a separate vapor. Controlling the evaporation rates of the various reaction products from the electrolyte 106 at different temperatures may facilitate achieving a refined operational window in which the mass loss of the oxidation product of the base metal (e.g., aluminum chloride) may be controlled.

The distillation module 102 may generally separate the oxidation product of the base metal into a separate stream exiting the distillation module 102. Further, or instead, a second stream exiting the distillation unit may include components (vapor) with lower boiling points than the oxidation product of the base metal. Still further, or instead, a third stream exiting the distillation module 102 may include slag of reaction products with higher boiling points than the oxidation product of the base metal. It shall be appreciated that additional streams may exit the distillation module 102 to the extent the system 100 separates the reaction products beyond the separation associated with purifying the base metal according to the techniques described herein.

Due to high vapor pressure of AlCl₃ (T_{sublime}=180° C.), the volatility of ternary AlCl₃—NaCl—KCl compositions may be evaluated as a function of temperature (100-300° C.) and AlCl₃ content (40-60 mol %). The degree of AlCl₃ volatility may be quantified by determining mass loss and chemical composition of the electrolyte 106 after 10 h testing at a given temperature under an inert argon atmosphere. A thermal distillation apparatus may be used to assess mass loss of the electrolyte 106 and the chemical composition of volatile species over a range of temperature. In case the electrolyte 106 loss is greater than 10% of initial mass, composition of the electrolyte 106 may be modified by adding other chlorides (e.g., LiCl, MgCl2, CaCl2)). The melting temperatures of multi-component electrolytes (e.g., AlCl3-NaCl—KCl—MgCl2) can be determined using thermal analyzer via differential scanning calorimetry (DSC). This information may be consolidated to an electrolyte composition and temperature range which gives stable properties even in the presence of contaminants in the electrolyte 106. While the foregoing has been described in the context of aluminum-chloride chemistry, it shall be appreciated that stability ranges of the electrolyte 106 may be similarly assessed for other types of chemistry such that the electrolyte 106 may be recycled and/or used in the electrolysis cell 103 following removal of the reaction products from the electrolyte 106 passing through the distillation module 102.

While the oxidation product of the base metal separated by the distillation module 102 may move directly to the electrolysis cell 103 in some instances, it shall be appreciated that the oxidation product of the base metal may move through a heat exchanger 109 in certain implementations. For example, the heat exchanger 109 may be in thermal communication between an outlet 110 of the electrolysis cell 103 and an inlet 111 of the electrolysis cell 103. As described in greater detail below, operation of the electrolysis cell 103 in the electrolysis mode may produce oxygen-free oxidant exiting the outlet 110 of the electrolysis cell 103 at an elevated temperature (e.g., >600° C.). Continuing with this example, the oxygen-free oxidant may move through the heat exchanger 109 such that heat at least some of the heat from the oxygen-free oxidant preheats (e.g., between 150° C. to 200° C.) the oxidation product of the base metal separated by the distillation module 102 and moving into the inlet 111 of the electrolysis cell 103. In certain implementations, the rate at which the oxidation product of the base metal is fed into the electrolysis cell 103 may be used to determine the heat transfer rate from the hot stream of the oxygen-free oxidant to the cooler stream of the oxidation product of the base metal. Further, or instead, in instances in which the electrolysis cell 103 is ramped down, the system 100 may further include an insulation shield 112 removably securable about the electrolysis cell 103 between electrolysis cycles of the electrolysis cell 103 (e.g., as part of an intermittent use protocol), as may be useful for maintaining the electrolyte 106 in a molten form in the electrolysis cell 103.

In general, the electrolysis cell 103 may be any one or more of various different types of electrochemical cells compatible with chemistry of the discharge cell 101 to reduce the oxidation product of the base metal separated by the distillation module 102 to form the second composition of the base metal and the oxygen-free oxidant. As described above, it shall be understood that the electrolysis cell 103 may include any one or more of the features of any one or more of the discharge cell 101 and, for the sake of clear and efficient description, these are not described separately. For example, the discharge cell 101 and the electrolysis cell 103 may be the same type of electrochemical reactor. As a specific example, the discharge cell 101 and the electrolysis cell 103 may be the same instance of an electrochemical reactor alternating between the discharge mode and the electrolysis mode to carry out the purification processes described herein. In certain instances, the electrolysis cell 103 may be co-located with the discharge cell 101 and, continuing with this example, the electrolysis cell 103 and the discharge cell 101 may be operable in coordination with one another such that little or no storage of material streams is required. Alternatively, such as in instances in which the electrolysis cell 103 and the discharge cell 101 are not co-located with one another (e.g., to take advantage of lower cost energy in certain locations), it shall be appreciated that any one or more of the material streams described herein may be stored such that the electrolysis cell 103 may be asynchronously operated with respect to operation of the discharge cell 101. operable along with the discharge cell 101.

In certain implementations, the electrolysis cell may include an insulation jacket 134 in thermal communication the anode, the cathode, and the electrolyte of the electrolysis cell, and the one or more reaction products separated from the oxidation product of the base metal may be controllably flowable through the insulation jacket 134 to maintain a target temperature of the electrolysis cell between electrolysis cycles.

In certain implementations, the system 100 may include a return circuit 113 in fluid communication between the electrolysis cell 103 and the discharge cell such that the oxygen-free oxidant produced by operation of the electrolysis cell 103 in the electrolysis mode may flow into the discharge cell 101 via the return circuit 113. It shall be appreciated that the return circuit 113 may facilitate continuous or semi-continuous operation of the system 100 by providing a supply of the oxygen-free oxidant for operation of the discharge cell 101 in the discharge mode. The return circuit 113 may include conduits, valves, or pumping systems, as may be necessary or useful for transporting the oxygen-free oxidant from the electrolysis cell 103 back to the discharge cell 101. Further, or instead, the return circuit 113 may include one or more purification or separation stages to remove contaminants from the oxygen-free oxidant prior to introduction of the oxygen-free oxidant into the discharge cell 101. In instances in which the oxygen-free oxidant is a gas, the return circuit 113 may further, or instead, include pressure regulation and gas handling equipment such as compressors, filters, or condensers. Further, while the return circuit 113 may provide a substantial amount of the oxygen-free oxidant required for operation of the discharge cell 101 in the discharge mode, it shall be appreciated that a makeup supply of the oxygen-free oxidant may be provided to the discharge cell 101 to replace amounts of the oxygen-free oxidant that may be lost (e.g., through the distillation module 102) as the system 100 operates.

In certain implementations, the system 100 may include one or more storage vessels to facilitate asynchronous operation and/or to facilitate consistent performance of the system 100 over prolonged continuous operation. For example, the discharge cell 101 may be capable of cycling the anode 104 on the order of 1 cm thick over extended run times. Discharging the anode 104 over an extended period of time (e.g., 100 hours) may result in the formation of a large amount of oxidation product of the base metal (e.g., aluminum chloride), which may drastically alter the composition of the electrolyte 106 over such time scales. Thus, in some instances, the increasing concentration of the oxidation product of the base metal in the electrolyte 106 may be diluted in be diluted in an electrolyte reservoir 114, and the electrolyte 106 may be cycled from the discharge cell 101 to the electrolyte reservoir 114. The electrolyte reservoir 114 may be sized for a continuous discharge to demonstrate high utilization of a first composition of the base metal of the anode 104. Further, or instead, the electrolyte reservoir 114 and other storage vessels may facilitate batch processing and/or asynchronous operation of the discharge cell 101 relative to the electrolysis cell 103.

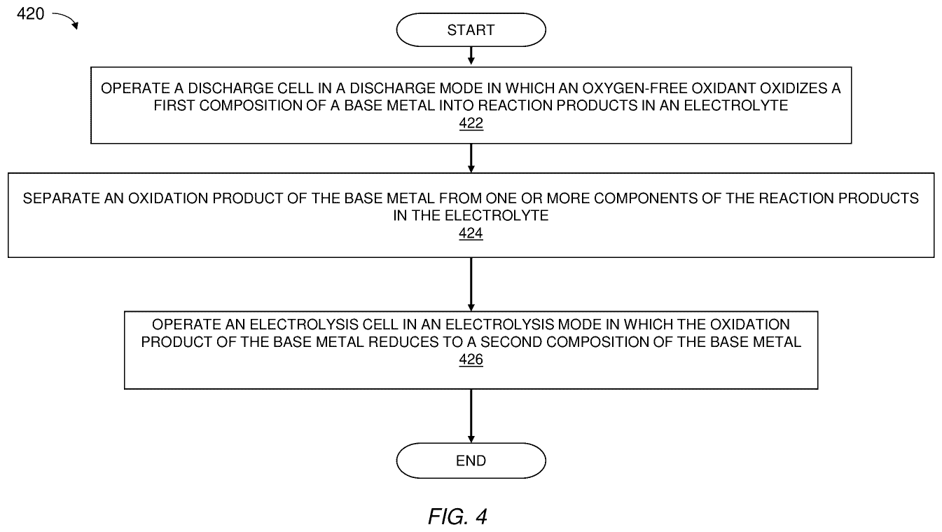

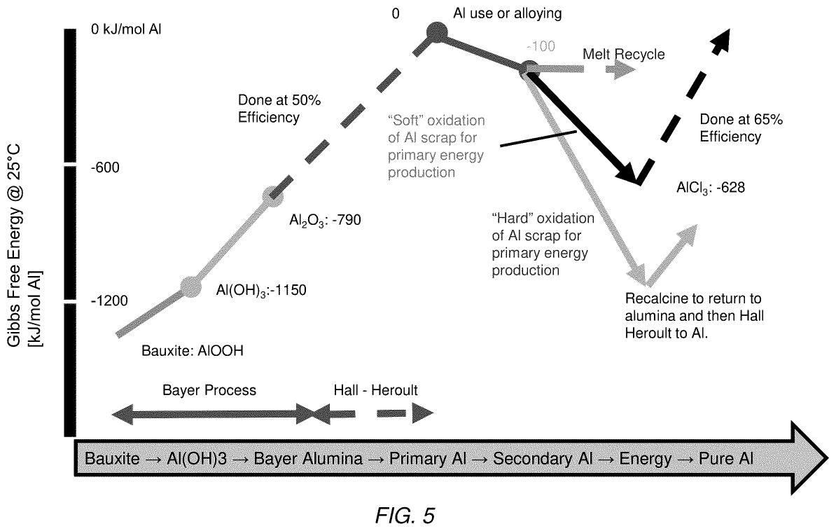

Referring now to FIGS. 4-6, an exemplary method 420 of purifying a metal-containing material may be carried out using any one or more aspects of the systems described herein (e.g., the system 100 in FIG. 1) for purifying a metal-containing material according to a “soft” oxidation route in which energy is recovered during oxidation and lower input energy is required during electrolysis, resulting in improved round-trip energy efficiency compared to conventional aluminum-air and Hall-Héroult processes. In particular, the exemplary method 420 may rely on soft oxidation of metal (e.g., post-consumer scrap metal) that avoids the formation of metal oxides, which present challenges in electrolysis and purification. The product of the discharge reaction—the oxidation product of the base metal—is free of oxygen and is, thus, much more facile to electrolyze than products of oxygen-based oxidation (typically Al(OH)3, Al2O3, or other similar oxides or hydroxides). Electrolysis of the oxidation product of the base metal (e.g., aluminum chloride in the case of aluminum-chloride chemistry) consumes significantly less energy than electrolysis of oxides or hydroxides and may facilitate the use of dimensionally stable anodes (DSA) made up of materials like graphite and corrosion resistant steels.

Soft oxidation of scrap aluminum to form a more purified form of aluminum is a particularly relevant use case, given the ubiquity of scrap aluminum and the robust secondary market for recycled aluminum. The overall process of discharging scrap aluminum and then electrolyzing the resulting aluminum chloride into aluminum metal can be described as “upcycling” scrap aluminum. The half cells reactions are as follows:

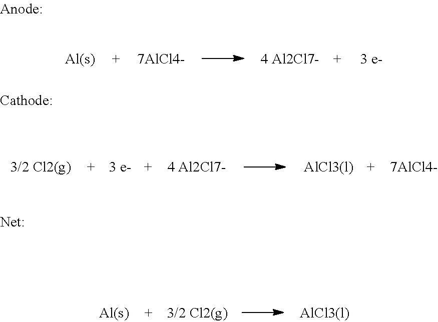

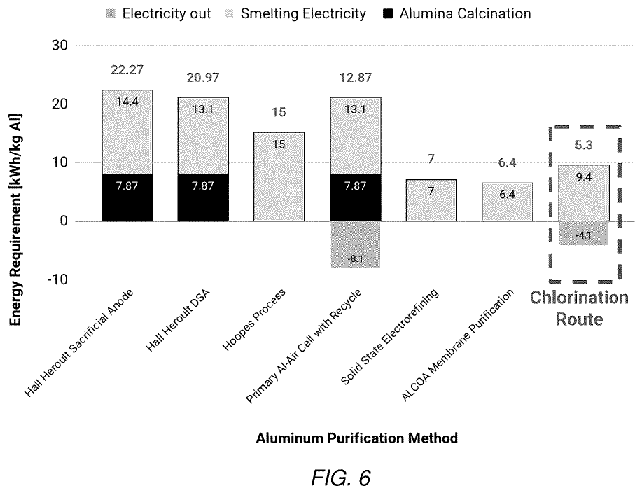

Carrying out these reactions according to the exemplary method 420 may require less energy and improve material purification relative to “hard oxidation” which requires recalcination of scrap aluminum to return alumina and then the Hall-Héroult process to return aluminum. Stated differently, carrying out the exemplary method 420 using any one or more aspects of the systems (e.g., the system 100 of FIG. 1) described herein may require less net energy than other aluminum purification techniques (see FIG. 6) than other galvanic and electrolytic processes for recycling aluminum. Further, the exemplary method 420, may facilitate achieving higher purity of the aluminum produced as the end-product at least because, as described above, the oxidation products resulting from the exemplary method 420 are readily separable (e.g., through distillation) compared to oxides and hydroxides.

The reversible nature of the exemplary method 420 may facilitate upgrading impure or contaminated metal feedstocks as well as electrochemical energy storage or generation. The ability to oxidize and reduce light metals such as aluminum, magnesium, or titanium using non-oxygen oxidants like halides or sulfur facilitate carrying out a closed-loop cycle in which valuable metals are recovered and reused with less waste or emissions relative to other techniques. Additionally, the co-generation of electric power during oxidation provides an added benefit over conventional recycling techniques, which typically require external energy input and result in net energy loss. Thus, exemplary method 420 may provide an integrated pathway for metal recovery and clean energy utilization.

As shown in step 422, the exemplary method 420 may include operating a discharge cell in a discharge mode in which an oxygen-free oxidant from a cathode oxidizes a first composition of a base metal of an anode into reaction products in an electrolyte. The base metal may be any one or more light metals, such as aluminum, magnesium, or titanium. Further or instead, the oxygen-free oxidant may include chlorine, fluorine, bromine, iodine, or a combination thereof, such that the oxidation product of the base metal is a metal halide. Further, or instead, the oxygen-free oxidant may include sulfur, and the oxidation product of the base metal may be a metal sulfide. Given that the oxidation products are formed using the oxygen-free oxidant, the reaction products are free of oxides (e.g., carbon dioxide-free) and hydroxides. Thus, the oxidation products of the impurities (e.g., silicon, lead, iron, zinc, copper, manganese, magnesium, or combinations thereof) may be effectively separated from the oxidation product of the base metal using distillation. Accordingly, the quality of the purified end-product of the base metal may be relatively insensitive to the amount of impurities in the first composition of the base metal. That is, the first composition of the base metal may be a low-quality composition of the base metal—which may be economically sourced—with little or no impact on the quality of the purified end-product of the base metal. Thus, for example, the first composition of the base metal may include greater than 80 weight percent of the base metal and, in certain instances, may include less than 97 weight percent of the base metal.

In certain instances, operating the discharge cell in the discharge mode may include generating electrical power at the discharge cell. The electrical power may be collected as a useful byproduct of operation of the discharge cell in the discharge mode. For example, the electrical power may be used to power any one or more of various components of a system (e.g., the system 100) used to carry out the exemplary method 420 and, more generally, may contribute to reducing the net energy requirement associated with carrying out the exemplary method 420. In certain instances, the electrical power generated at the discharge cell may be at least 4 kWh of electrical energy per kilogram of the base metal in the first composition of the base metal. Further, or instead, operating the discharge cell in the discharge mode may include continuously generating power at rated power of the discharge cell for at least 10 hours. Further, or instead, operating the discharge cell in the discharge mode may include intermittently operating the discharge cell in the discharge mode. As an example, intermittently operating the discharge cell in the discharge mode may include restarting the discharge cell from a temperature above the eutectic temperature of the molten salt eutectic and below the melting point of the first composition of the base metal in the anode.

In general, the first composition of the base metal in the anode may be in any one or more of the various forms described herein. Thus, for example, the first composition of the base metal may be in a molten state in the anode. Additionally, or alternatively, the first composition of the base metal may be in a solid state in the anode. For example, operating the discharge cell in the discharge mode may include forming the first composition of the base metal in the solid state with a void volume ranging from 1 volume percent to 80 volume percent (e.g., using one or more of crushing, shredding, melting, grinding, or pressing the first composition of the base metal into a shape of the anode).

The electrolyte may be any one or more of the various different electrolytes described herein, unless otherwise specified or made clear from the context. For example, the electrolyte may include a molten salt eutectic. The molten salt eutectic may have a eutectic temperature less than a melting point of the first composition of the base metal in the anode. Further, or instead, the relative densities of the electrolyte, the base metal of the anode, and the oxygen-free oxidant from the cathode may resist inversion of the discharge cell. Thus, for example, the first composition of the base metal of the anode may have a first density, the electrolyte has a second density, the oxygen-free oxidant from the cathode has a third density, the first density is greater than the second density at a temperature below the eutectic temperature of the molten salt, and the second density is greater than the third density at the temperature below the eutectic temperature of the molten salt.

In general, operating the discharge cell in the discharge mode may include introducing the oxygen-free oxidant into the electrolyte according to any one or more of the various different techniques described herein. For example, introducing the oxygen-free oxidant into the electrolyte may include introducing the oxygen-free oxidant in a gaseous form into the electrolyte. As a specific example, introducing the oxygen-free oxidant in the gaseous form into the electrolyte may include moving the oxygen-free oxidant into the electrolyte via a gas diffusion electrode of the discharge cell. Further, or instead, introducing the oxygen-free oxidant in the gaseous form into the electrolyte may include sparging the gaseous form of the oxygen-free oxidant into the electrolyte, as described in greater detail below. Additionally, or alternatively, operating the discharge cell in the discharge mode may include introducing the oxygen-free oxidant in a liquid form into the electrolyte, as described in greater detail below.

As shown in step 424, the exemplary method 420 may include separating an oxidation product of the base metal from one or more components of the reaction products in the electrolyte. In certain instances, the oxidation product of the base metal may be separated from the one or more components of the reaction products along a flow path in fluid communication between the discharge cell and the electrolysis cell. For example, separating the oxidation product of the base metal from the one or more components of the reaction products in the electrolyte may include distilling the one or more components of the reaction products from the electrolyte. As a specific example, distilling the oxidation product of the base metal from the one or more components of the reaction products in the electrolyte may include collecting vapor of the one or more components of the reaction products having a lower boiling temperature than the oxidation product of the base metal. Further, or instead, distilling the one or more components of the reaction products from the electrolyte may include collecting vapor of the one or more components of the reaction products separated from the electrolyte.

As shown in step 426, the exemplary method 420 may include operating an electrolysis cell in an electrolysis mode in which the oxidation product of the base metal separated from the one or more components of the reaction products reduces to a second composition of the base metal, the second composition having a greater weight percentage of the base metal as compared to the first composition. In some instances, operating the electrolysis cell in the electrolysis mode may include receiving electrical power generated by operating the discharge cell in the discharge mode such that the net power used to carry out the exemplary method 420 may be reduced. Further, or instead, given the efficacy with which the oxygen-free reaction products may be removed from the electrolyte, the second composition of the base metal may be high (e.g., at least about 99.5 weight percent of the base metal). In instances in which the base metal is aluminum, the effectiveness with which removal of oxygen-free oxidation products of impurities may be removed from the electrolyte (e.g., as a result of non-overlapping temperature ranges of vapor pressures) may facilitate achieving aluminum with purity greater than purity achievable using the Hall-Héroult process (e.g., greater than 99.9 weight percent of the aluminum).

In general, operating the electrolysis cell in the electrolysis mode may produce the second composition of the base metal in any one or more forms. For example, the electrolysis cell operating in the electrolysis mode may form the second composition of the base metal as a solid in the electrolysis cell. Further, or instead, operating the electrolysis cell in the electrolysis mode may include forming the second composition of the base metal in a molten state and casting the molten state into a solid state of the second composition of the base metal (e.g., a solid state with a void volume less than 5 volume percent).

In certain instances, operating the electrolysis cell in the electrolysis mode may produce the oxygen-free oxidant in a vapor phase. Continuing with this example, the oxidation product of the base metal entering the electrolysis cell may be preheated via heat transfer from the oxygen-free oxidant in the vapor phase produced by the electrolysis cell. Further, or instead, operating the electrolysis cell in the electrolysis mode may include flowing the oxygen-free oxidant in the vapor phase, produced by the electrolysis cell, to the discharge cell via a return circuit in fluid communication between the electrolysis cell and the discharge cell. Still further, or instead, operating the discharge cell in the discharge mode may include flowing a make-up volume of the oxygen-free oxidant into the discharge cell.

In some implementations, operating the electrolysis cell in the electrolysis mode may include intermittently operating the electrolysis cell in the electrolysis mode. For example, intermittently operating the electrolysis cell in the electrolysis mode may include heating the electrolysis cell with heat transfer from the molten salt eutectic.

Having described various aspects of the system 100 (FIG. 1) and the exemplary method 420 (FIG. 4), attention is directed now to certain aspects of thermal management to facilitate robust and efficient performance of the metal purification techniques described herein under a variety of conditions, including continuous and intermittent operation.

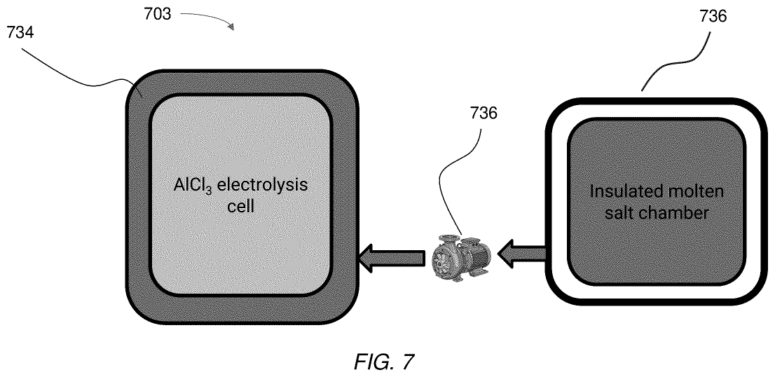

Referring now to FIG. 7, an electrolysis cell 703 may include an insulation jacket 734 in thermal communication with one or more electrodes of the electrolysis cell. A reservoir 735 of a molten salt eutectic (e.g., an electrolyte used in the electrolysis cell 703) may be in fluid communication with the insulation jacket 734 via a pump 736. The pump 736 may be controllable to circulate the molten salt eutectic between the reservoir 735 and the insulation jacket 734 to maintain a target temperature of the electrolysis cell 703, as may be useful for intermittent operation of the electrolysis cell 703.

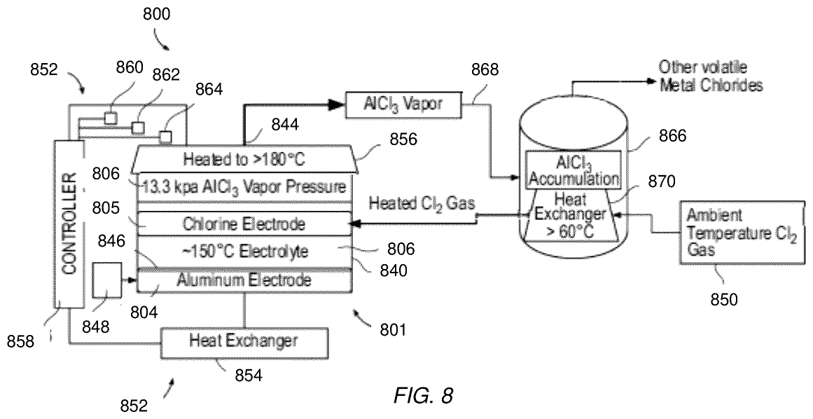

Referring now to FIG. 8, a system 800 that may be used to process substantially any aluminum metal-containing material, including aluminum scrap, to obtain aluminum halide while also extracting chemical energy and generating electricity. The aluminum halide may have many downstream uses and may even be converted into aluminum metal of the highest purity if desired. The system 800 may include a discharge cell 801. The discharge cell 801 may include a vessel 840 that contains an electrolyte 806, as well as an anode 804 and a cathode 805 immersed in the electrolyte 806. A headspace 842 is defined by the vessel 840 above the anode 804 and the cathode 805 and a vapor discharge outlet 844 may be in fluid communication with the headspace 842.

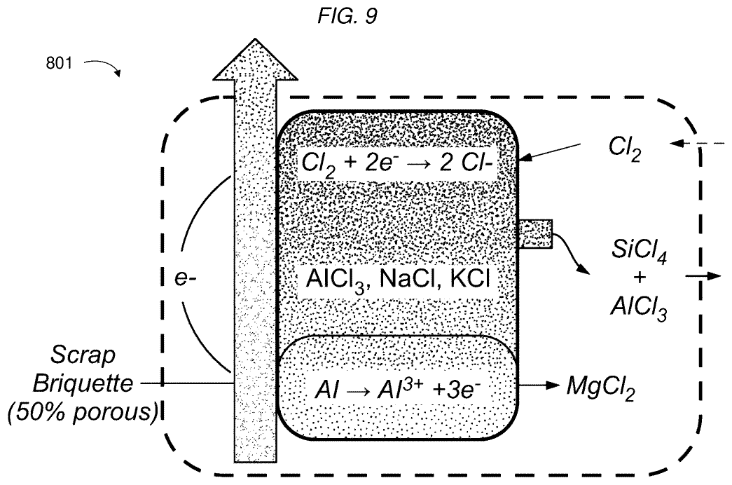

Referring now to FIGS. 8 and 9, during operation of the cell, aluminum at the anode 804, may react with the halide, in the illustrated embodiment chloride anion (Cl−), generated at the cathode 805, in an exothermic reaction to produce aluminum chloride (AlCl₃) and provide a cell voltage of 2.1 Volts versus a standard hydrogen electrode (SHE).

The anode 804 may comprise consumable aluminum. The consumable aluminum may have a porosity of 25% 30%, 35%, or 40% to 55%, 60%, 65%, or 70%. In one possible embodiment, the consumable aluminum has a porosity of 50%. For purposes of continuous operation of the discharge cell 801, the 804 may take many forms, including, but not necessarily limited to, (a) a scrap briquette or roll of aluminum material of desired porosity that may be continuously fed into the discharge cell 801 as the anode 804 is consumed or (b) a current collector 846 (e.g., a rigid mesh) though which an aluminum slurry may be continuously fed from an aluminum supply 848.

The cathode 805 may also take many forms, including, but not necessarily limited to (a) a gas diffusion electrode fed chlorine gas from a chlorine supply 850, or (b) an electrode submerged in the molten salt electrolyte and adapted to reduce chlorine (Cl2), dissolved in the electrolyte, to provide the chloride anion (Cl−). The chlorine may be fed into the electrolyte 806 through a porous frit adjacent to the cathode 805. The cathode 805 may comprise a carbonaceous material and may, or may not, incorporate a catalyst suitable for chloride anion generation (e.g., a ruthenium or a titanium catalyst).

The system 800 may also include a thermal gradient generation system 852. The thermal gradient generation system 852 may include a heat exchanger 854, a heating system 856 and a controller 858. The heat exchanger 854 may be operatively connected to the anode 804 which provides the primary source for thermal transfer and temperature control. In some implementations, the heat exchanger 854 may be connected to the current collector 846 associated with the anode 804. Further, or instead, the heat exchanger 854 may heat or cool the consumable aluminum (e.g., an aluminum slurry) fed to the anode 804 to maintain a predetermined operating temperature at the anode 804.

The heating system 856 may be operatively connected with the vapor discharge outlet 844 and, in some embodiments, the top wall of the vessel 840. The heating system 856 may control (a) the temperature of the walls of the vessel 840 at the headspace e842 and (b) the temperature of the composition of materials being exhausted through the vapor discharge outlet 844, including the aluminum halide and optionally the other accumulating chemical species such as silicon chloride.

The controller 858 may include a processing unit and non-transitory, computer-readable storage media having stored thereon instructions for causing the processing unit to control the operation of both the heat exchanger 854 and the heating system 856 to establish and maintain a target thermal gradient for the molten salt electrolyte as well as the chemical species accumulating as a result of the chemical reactions taking place at the anode 804. More specifically, the molten salt of the electrolyte 806 at the anode 804 may be maintained at a first temperature T1, the wall of the vessel 840 at the headspace 842 of the discharge cell 801 may be maintained at a second temperature T2, and the aluminum halide and other accumulating chemical species being delivered from the discharge cell 801 at the vapor discharge outlet 844 are maintained at a third temperature T3 at or above the bubble temperature of aluminum halide. Typically, T1<T3<T2.

Referring now to FIG. 3, the operational temperature regime (OTR) for the process is shown. For the discharge cell 801 producing aluminum chloride from an anode 804 including aluminum, the thermal gradient may comprise a temperature T1 of 110° C. to 175° C., a temperature T2 of 120° C. to 200° C. and a temperature T3 of 150° C. to 190° C. In some implementations, the temperature gradient may include a temperature T1 of 150° C., a temperature T2 of 150° C. to 179° C. and a temperature T3 of 180° C. In an aspect, T1 may be 115° C. to 165° C., 120° C. to 160° C., 125° C. to 155° C., or 130° C. to 150° C. In an aspect, T2 may be 125° C. to 190° C., 130° C. to 180° C., 140° C. to 170° C., or 150° C. to 160° C. In an aspect, T3 may be 160° C. to 185° C., 165° C. to 180° C., or 170° C. to 175° C.

For an instance of the discharge cell 801 producing aluminum bromide, the thermal gradient may comprise a temperature T1 of 150° C. to 240° C., a temperature T2 of 200° C. to 300° C. and a temperature T3 of 230° C. to 285° C. In some instances, the temperature gradient comprises a temperature T1 of 225° C., a temperature T2 of 225° C. to 285° C. and a temperature T3 of at least 255° C. In an aspect, T1 may be 190° C. to 240° C., 195° C. to 235° C., 200° C. to 230° C., or 205° C. to 225° C. In an aspect, T2 may be 200° C. to 285° C., 205° C. to 275° C., 215° C. to 265° C., or 225° C. to 255° C. In an aspect, T3 may be of 235° C. to 285° C., 240° C. to 280° C., or 245° C. to 270° C.

The indicated temperature T1 functions to ensure that the electrolyte in and around the anode 804 does not freeze and is suitable for the aluminum metal to react with halide anions to produce the aluminum halide. As the reaction is exothermic, depending on the feed rate of the consumable aluminum and chlorine or bromine to the discharge cell 801, at times it may be desirable for the heat exchanger 854 to provide cooling through the anode 804 while, at other times, the heat exchanger 854 may provide heating through the anode 804 to maintain the desired temperature of the electrolyte 806 at the anode 804. A thermal sensor 860, of a type known in the art, may be used to monitor the temperature of the electrolyte 806 at the anode 804 and provide temperature data to the controller 858.

The indicated temperature T2 functions to ensure that a desired aluminum halide vapor pressure is maintained at the headspace 842 to allow for free evaporation of the accumulating aluminum halide. The pressure is typically 80 to 150 kiloPascals (kPa). In some implementations, the aluminum chloride vapor pressure maintained at the headspace 842 may be 5 to 20 kPa, 7 to 18 kPa, 9 to 16 kPa, or 13.3 kPa. In an aspect, the aluminum bromide vapor pressure maintained at the headspace 842 may be 5 to 20 kPa, 7 to 18 kPa, 9 to 16 kPa, or 13.3 kPa. A thermal sensor 862, of a type known in the art, may be used to monitor the temperature of the vessel walls at the headspace 842 and provide temperature data to the controller 858.

The indicated temperature T3 functions to ensure that the aluminum halide gas evaporating out of the electrolyte 806 remains above its sublimation temperature (180° C. for aluminum chloride) to resist aluminum halide solidification at the vapor discharge outlet 844. A thermal sensor 864, of a type known in the art, may be used to monitor the temperature of the vapor discharge outlet 844 and provide temperature data to the controller 858.

The system 800 may additionally include a recovery vessel 44 downstream from the vapor discharge outlet 844. A feed line 868 leading from the vapor discharge outlet 844 to the recovery vessel 866 is also maintained by the heating system 856 at a temperature above aluminum halide's sublimation temperature to resist solidification of aluminum halide in the feed line 868. The system 800 functions to separate and collect aluminum halide from other metal halides, such as silicon chloride or silicon bromide, in the composition discharged from the discharge cell 801 at the vapor discharge outlet 844.

Toward this end, the recovery vessel 866 may include a condenser 870 that operates at a temperature above the boiling point of the other metal halides, such as silicon chloride, which has a boiling point of 57.6° C. In some implementations, the condenser 870 operates at greater than 60° C. As a result, the aluminum halide condenses and is recovered as a liquid or a solid from the bottom of the recovery vessel 866 while other volatile metal halides, such as the silicon halide, are exhausted as gases from the top of the recovery vessel 866, where they may be collected for further downstream processing.

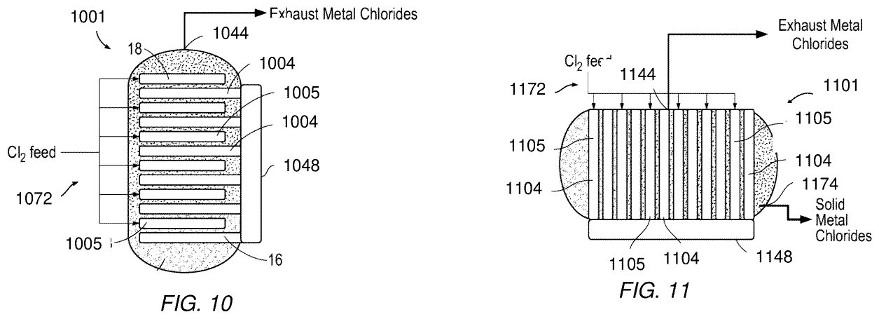

Referring now FIG. 10, a discharge cell 1001 may be a bipolar cell of vertical design. Note the vertical stack of instances of anodes 1004 and cathodes 1005. The spacing or gap between the anodes 1004 and the cathodes 1005 may be 0.5 cm to 1 cm. The halogen may be fed to each of the cathodes 1005 by a feed system 1072 while aluminum is fed to each of the anodes 1004 from an aluminum supply 1048. A vapor discharge outlet 1044 is at the top of the discharge cell 1001.

Referring now to FIG. 11, a discharge cell 1101 may be a bipolar cell of horizontal design. Note the horizontal stack of alternating anodes 1104 and cathodes 1105. The spacing or gap between the anodes 1104 and the cathodes 1105 may be 0.5 cm to 1 cm. Halogen may be fed to each of the cathodes 1105 by a feed system 1172 while aluminum is fed to each one of the anodes 1104 from the aluminum supply 1148. A vapor discharge outlet 1144 may be provided at the top of the discharge cell 1101. A slag outlet 1174 adjacent the bottom of the discharge cell 1101 for the discharge of heavier metal halide slags that do not rise to the vapor discharge outlet 1144.

Referring again to FIG. 8, the system 800 may be useful in a method of recovering the aluminum halide. That method may include a step of providing the discharge cell 801 comprising the vessel 840, the anode 804, the cathode 805, the headspace 842, the vapor discharge outlet 844, and the electrolyte 806. The method may also, or instead, include the steps of: (a) maintaining the electrolyte 806 adjacent the anode 804 in the discharge cell 801 at a first temperature T1, (b) maintaining the walls of the vessel 840 at the headspace 842 of the discharge cell 801 at a second temperature T2, and (c) maintaining a composition comprising the aluminum halide at the aluminum halide vapor discharge outlet at a third temperature T3 at or above a bubble temperature of the aluminum halide. The system 800 may be sealed and operated with an internal pressure at or above ambient and exclude moisture (H2O) and elemental oxygen (O2).

As noted above, the resulting thermal gradient may be established and maintained by the thermal gradient generation system 852. More particularly, the heat exchanger 854, under control of the controller 858, may heat or cool the anode 804, to establish and maintain an optimal temperature T1 of the electrolyte 806 in and around the anode 804 to support halogenation of the consumable aluminum of the anode 804. In addition, the heating system 856, also under control of the controller 858, (a) may heat the walls of the vessel 840 at the headspace 842 to the temperature T2 for encouraging evaporation of the aluminum halide accumulating in the electrolyte 806, and (b) may heat the vapor discharge outlet 844 to a temperature T3 above the bubble temperature of the aluminum halide being discharged from the discharge cell 801. Mentioned is an aspect wherein T1<T3<T2.

As noted above, for aluminum chloride, T1 is 110° C. to 175° C., T2 is 120° C. to 200° C. and T3 is 150° C. to 190° C. In one possible embodiment, the temperature gradient comprises a temperature T1 of 150° C., a temperature T2 of 150° C. to 179° C. and a temperature T3 of 180° C. In an aspect, T1 may be 115° C. to 165° C., 120° C. to 160° C., 125° C. to 155° C., or 130° C. to 150° C. In an aspect, T2 may be 125° C. to 190° C., 130° C. to 180° C., 140° C. to 170° C., or 150° C. to 160° C. In an aspect, T3 may be 160° C. to 185° C., 165° C. to 180° C., or 170° C. to 175° C. For an electrochemical cell 12 producing aluminum bromide, the thermal gradient may comprise a temperature T1 of 190° C. to 240° C., a temperature T2 of 200° C. to 285° C. and a temperature T3 of 235° C. to 285° C. In one possible embodiment, the temperature gradient comprises a temperature T1 of 225° C., a temperature T2 of 225° C. to 285° C. and a temperature T3 of at least 255° C. In an aspect, T1 may be 190° C. to 240° C., 195° C. to 235° C., 200° C. to 230° C., or 205° C. to 225° C. In an aspect, T2 may be 200° C. to 285° C., 205° C. to 275° C., 215° C. to 265° C., or 225° C. to 255° C. In an aspect, T3 may be of 235° C. to 285° C., 240° C. to 280° C., or 245° C. to 270° C.

The method may also allow for continuous production of aluminum halide by including one or more of the various additional steps set forth below: (a) continuously or semi-continuously feeding aluminum to the discharge cell 801 at the anode 804 in any appropriate manner such as the examples described above; (b) continuously feeding the halogen to the discharge cell 801 at the cathode 805 in any appropriate manner such as the examples described above; (c) preheating the halogen gas delivered to the cathode 805 to a temperature of 60° C. to 120° C.; (d) continuously accumulating aluminum halide in the headspace 842 of the discharge cell 801 and continuously discharging the aluminum halide accumulating in the headspace 842 at the vapor discharge outlet 844; and (e) transferring accumulating aluminum halide from the vapor discharge outlet 844 to the recovery vessel 866 adapted to separate the aluminum halide from any other accumulating chemical species generated at the anode 804.

Separating the aluminum halide may be accomplished by condensing the aluminum halide in the recovery vessel 866. For the separation and recovery of aluminum chloride from other metal chlorides, such as silicon chloride, that might have been formed at the anode 804, the method may include maintaining the condenser 870 above the boiling point of silicon chloride as set forth and described above.

Having described various aspects of thermal management for systems and methods of purifying metal-containing material, attention is now directed to certain aspects of feeding material to and from any one or more of the discharge cells or electrolysis cells described herein.

Referring again to FIG. 1, and with specific reference to aluminum-chlorine chemistry as an example, the anode 104 may be semi-continuously fed consumable aluminum from an aluminum supply 148. The anode 104 may contact the consumable aluminum with the chloride ions at the anode 104 to make the aluminum chloride.

During operation of the discharge cell 101, consumable aluminum at the anode 104 may react with the chloride anion (Cl−) in the electrolyte 106, previously generated from dissolved chlorine (Cl2) at the cathode 105, in an exothermic reaction to produce aluminum chloride (AlCl3) and provide a cell voltage of 2.1 Volts.

In general, the cathode 105 may take many different forms.

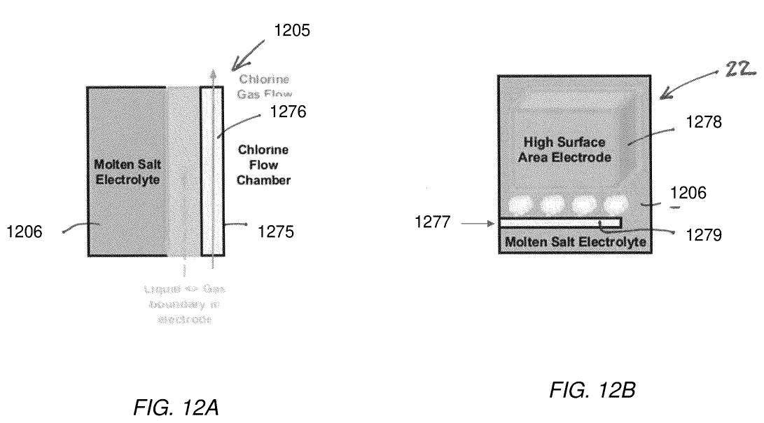

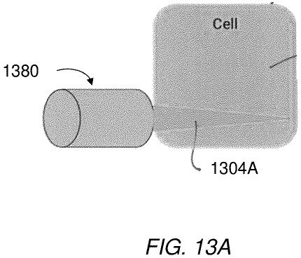

Referring now to FIG. 12A, a cathode 1205 comprises a body 1275 in the form of a gas diffusion electrode, adapted for generating chloride anions from chlorine. The body 1275 may include a chlorine flow field 1276 into which chlorine gas is receivable from a chlorine supply 1277. In certain implementations, the body 1275 may receive chlorine liquid.

Referring now to FIG. 12B, the cathode 1205 comprises a body 1278 and a gas sparger 1279, wherein the body 1278 is submerged in an electrolyte 1206 and the gas sparger 1279 is adjacent and below the body 1278 whereby chlorine gas is delivered through the gas sparger 1279 near the surface of the body 1278.

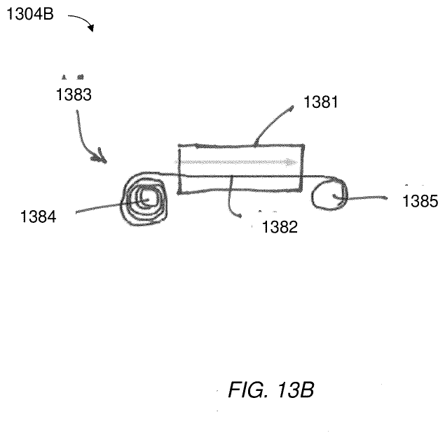

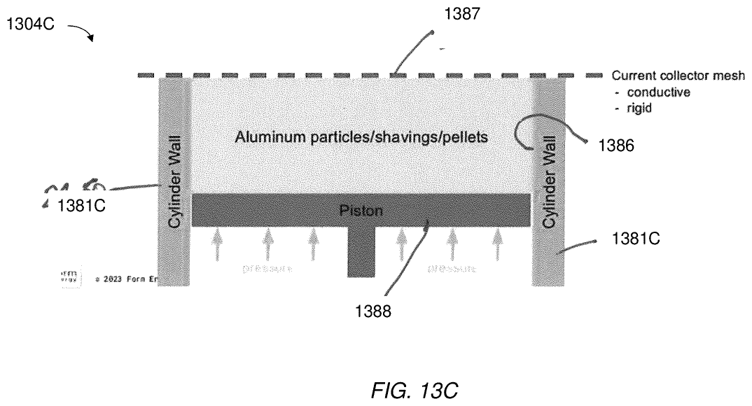

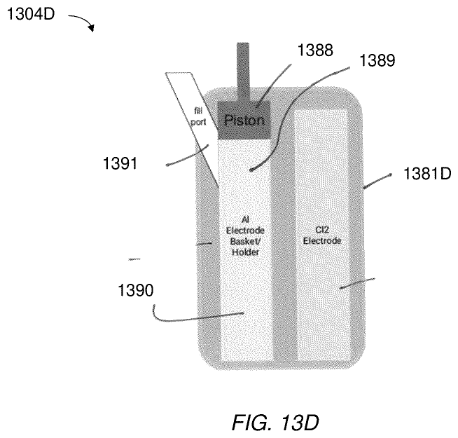

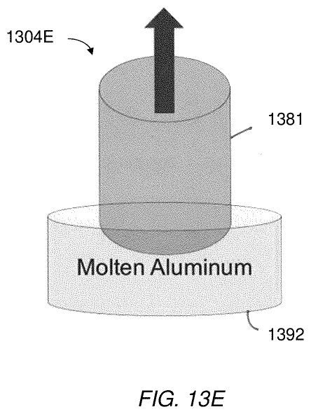

Referring now to FIG. 13A, for purposes of semi-continuous operation, an anode 1304A may include a body 1380 of solid aluminum semi-continuously fed or extruded by any appropriate mechanical feed mechanism into an electrolyte 1306 of a discharge cell 1301.

Referring now to FIG. 13B, an anode 1304B may semi-continuously feed consumable aluminum to a discharge cell (e.g., to the discharge cell 101 in FIG. 1). For example, the anode 1340B may include a body 1381 onto which is receivable an aluminum feed strip 1382 from a feed 1383. The feed 1383 may include a feed roll 1384 rotatable to feed the aluminum feed strip 1382 through the anode 1304B with any surplus aluminum strip, not oxidized at the anode 1304B, being taken up on the takeup roll 1385.

Referring now to FIG. 13C, an anode 1304C may include a body 1381C including a feed compartment 1386 having a first end closed by a current collector mesh 1387. A piston 1388 within the feed compartment 1386 may move to feed consumable aluminum (e.g., in the form of particles of desired porosity) from within the feed compartment 1386 through the current collector mesh 1387 into an electrolyte. In some instance, aluminum particles may be fed as slurry through the current collector mesh 1387.

Referring now to FIG. 13D, an anode 1304D may include a body 1381D including a current collector 1389 (e.g., a mesh or a foam), having a flow through chamber 1390 in communication with a gravity feed port 1391 adapted for feeding aluminum particles, of desired porosity, through the mesh or foam collector into an electrolyte. A piston 1388 may also be provided to apply appropriate pressure for desired operation.

Referring to FIG. 13E, an anode 1304E may include a body 1381E drawn from a molten aluminum source 1392 into the in a manner similar to the Czochralski process.

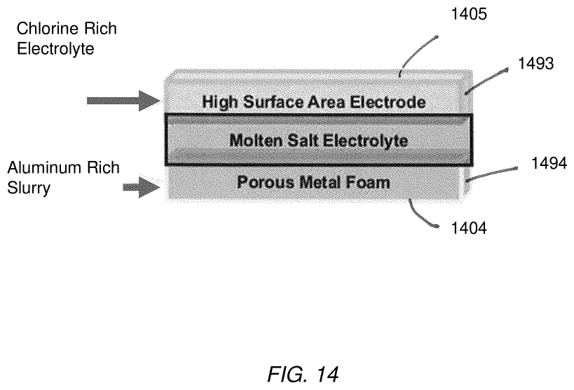

Referring now to FIG. 14, a cathode 1405 may have a first flowthrough chamber 1493 adapted to receive a chlorine gas, and an anode 1404 is a porous metal, such as a metal foam, having a feed compartment or second flow through chamber 1494 adapted to receive consumable aluminum, preferably in the form of a slurry.

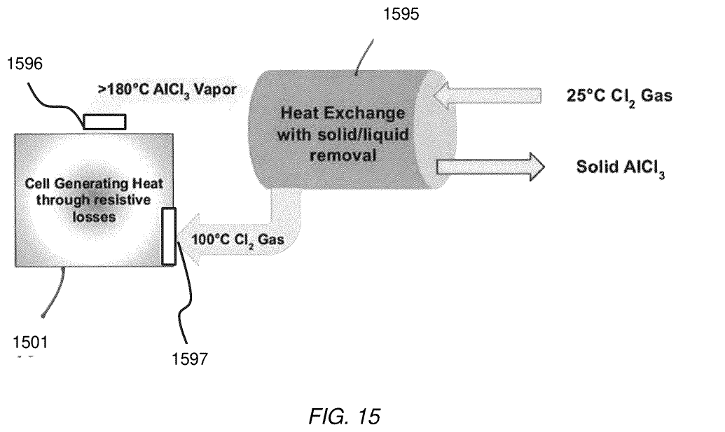

Referring now to FIG. 15, a heat exchanger 1595 may be in thermal communication between an outlet 1596 of a discharge cell 1501 and an inlet 1597 of the discharge cell 1501. Heat from the oxidation product of the base metal separated by any one or more of the distillation modules described herein may be transferrable, via the heat exchanger 1595, to an oxygen-free oxidant entering the inlet 1597 of the discharge cell 1501. As an example, the heat exchanger 1595 may include a thermal exchange liquid that solvates the oxidation product of the base metal at a temperature lower than an evaporation temperature of the thermal exchange liquid. Continuing with this example, the thermal exchange liquid may be heatable to re-release the oxidation product of the base metal moving into the electrolysis cell.

Having described various aspects of devices, systems, and methods associated with purifying metal, it shall be appreciated that the devices, systems, and methods described herein may be additionally or alternatively used for rechargeable power generation. For the sake of efficient description, such rechargeable description is described below with respect to a specific example of aluminum-sulfur chemistry. However, it should be appreciated that this is by way of example and should not be deemed limiting, as aspects may be achievable with other chemistries described herein.

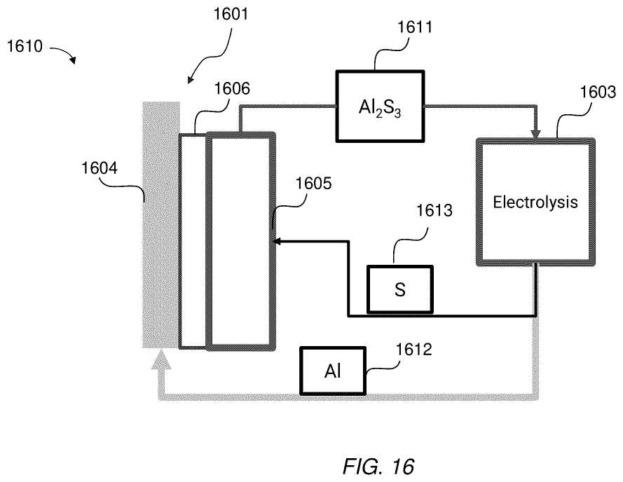

Referring now to FIG. 16, a system 1610 for mechanically rechargeable power generation may include a discharge cell 1601 may include an anode 1604, a cathode 1605, and an electrolyte 1606. During operation in discharge mode, aluminum and sulfur undergo an electrochemical reaction to form aluminum sulfide (Al₂S₃) 1611, while also generating electric power. The aluminum sulfide 1611 may be formed within the electrolyte 1606 or as a precipitate within or near the electrode regions, depending on operating conditions and cell design.

The aluminum sulfide 1611 may be delivered to an electrolysis cell 1603, where the aluminum sulfide 1611 dissociates into its elemental components through the application of electrical energy. The electrolysis process yields regenerated aluminum 1612 and regenerated sulfur 1613, which may be collected in elemental form or returned directly to the discharge cell 1601. The regenerated aluminum 1612 may be reformed into a new instance of the anode 1604, while the regenerated sulfur 818 may be returned to the cathode 1605 for further discharge cycles.

The closed-loop configuration of the system 1610 may be useful, for example, for a mechanically or thermochemically rechargeable energy system in which the aluminum and sulfur are cyclically oxidized and reduced. This approach decouples the discharge (power generation) and charge (electrolysis) stages, allowing for flexible deployment in systems where power demand and power availability are temporally or geographically separated. The process may also reduce reliance on external feedstocks and support sustainable operation through in-system material recycling.

The system 1610 may additionally, or alternatively, facilitate decoupling the discharge and electrolysis steps both temporally and geographically. In some embodiments, the aluminum-sulfur cell may be discharged at or near a load center where power is needed, and the resulting aluminum sulfide byproduct may be stored or transported to a remote facility for electrolysis. This separation enables the use of low-cost or renewable electricity for the energy-intensive electrolysis process, while allowing power generation to occur independently of grid constraints. The modular and rechargeable nature of the system facilitates flexible deployment across distributed energy systems and supports higher overall system efficiency compared to sealed, single-use battery architectures.

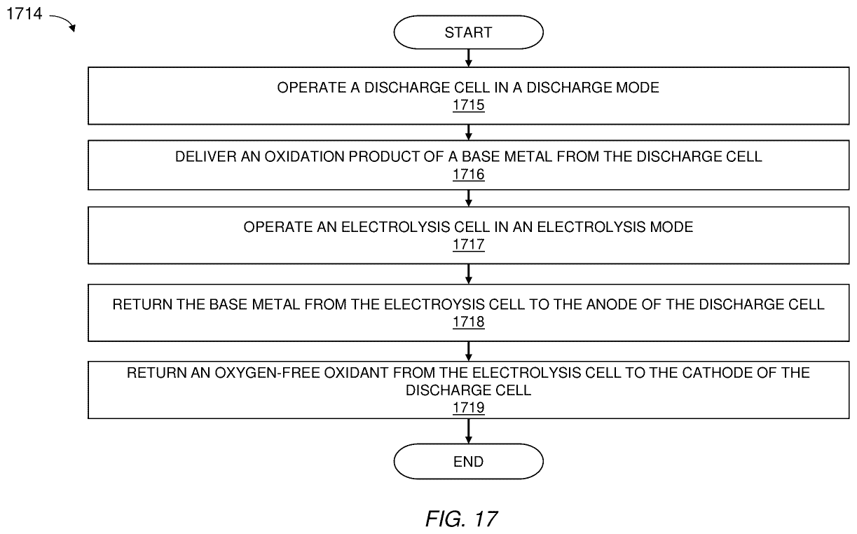

FIG. 17 is a flowchart of an exemplary method 1714 of mechanically rechargeable power generation. Unless otherwise specified or made clear from the context, it shall be appreciated that any one or more aspects of the exemplary method 1714 may be carried out using the system 1610 (FIG. 16).

As shown in step 1715, the exemplary method 1714 may include operating a discharge cell in a discharge mode in which, in an electrolyte, an oxygen-free oxidant from a cathode oxidizes a base metal of an anode into an oxidation product of the base metal. The cathode may be a molten cathode, and the oxidation product of the base metal formed by operating the discharge cell in the discharge mode may adsorb onto the molten cathode. As an example, the oxygen-free oxidant may be sulfur, and the oxidation product is a sulfide. In certain implementations, the electrolyte includes an inorganic eutectic. Further, or instead, base metal may be aluminum, magnesium, or a combination thereof.

As shown in step 1716, the exemplary method 1714 may include removing the oxidation product of the base metal from the discharge cell. For example, in instances in which the cathode is molten sulfur, removing the oxidation product of the base metal from the discharge cell may include removing the oxidation product of the base metal from the molten cathode. Further, or instead, removing the oxidation product of the base metal from the discharge cell may include storing the oxidation product of the base metal, and operating the electrolysis cell includes operating the electrolysis cell intermittently.

As shown in step 1717, the exemplary method 1714 may include operating an electrolysis cell in an electrolysis mode in which the oxidation product of the base metal removed from the discharge cell reduces to the base metal and the oxygen-free oxidant. In certain instances, the oxygen-free oxidant may be a gas (e.g. chlorine gas such that the oxidation product is a chloride or nitrogen gas such that the oxidation product is a nitride), and removing the oxidation product of the base metal from the discharge cell includes moving the electrolyte from the discharge cell, and operating the electrolysis cell includes receiving one or more components of the electrolyte removed from the discharge cell as a feedstock into the electrolysis cell. In certain implementations, operating the discharge cell and operating the electrolysis cell may be co-located with one another. Further, or instead, operating the discharge cell in the discharge mode produces power, and operating the electrolysis cell may include at least partially powering operation of the electrolysis cell using the power produced by operating the discharge cell in the discharge mode.

As shown in step 1718, the exemplary method 1714 may include returning the base metal from the electrolysis cell to the anode of the discharge cell.

As shown in step 1719, the exemplary method 1714 may include returning the oxygen-free oxidant from the electrolysis cell to the cathode of the discharge cell.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context.

The method steps of the implementations described herein are intended to include any suitable method of causing such method steps to be performed, consistent with the patentability of the following claims, unless a different meaning is expressly provided or otherwise clear from the context. So, for example performing the step of X includes any suitable method for causing another party such as a remote user, a remote processing resource (e.g., a server or cloud computer) or a machine to perform the step of X. Similarly, performing steps X, Y and Z may include any method of directing or controlling any combination of such other individuals or resources to perform steps X, Y and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

While particular embodiments have been shown and described, it will be apparent to those skilled in the art that various changes and modifications in form and details may be made therein without departing from the spirit and scope of this disclosure and are intended to form a part of the invention as defined by the following claims.

What is claimed is:

1. A method of purifying metal-containing material, the method comprising:
operating a discharge cell in a discharge mode in which an oxygen-free oxidant from a cathode oxidizes a first composition of a base metal of an anode into reaction products in an electrolyte;
separating an oxidation product of the base metal from one or more components of the reaction products in the electrolyte; and
operating an electrolysis cell in an electrolysis mode in which the oxidation product of the base metal separated from the one or more components of the reaction products reduces to a second composition of the base metal, the second composition having a greater weight percentage of the base metal as compared to the first composition.

2. The method of claim 1, wherein the base metal is aluminum, magnesium, or titanium.

3. The method of claim 1, wherein the oxygen-free oxidant includes chlorine, fluorine, bromine, iodine, or a combination thereof, and the oxidation product of the base metal is a metal halide.

4. The method of claim 1, wherein the oxygen-free oxidant includes sulfur, and the oxidation product of the base metal is a metal sulfide.

5. The method of claim 1, wherein the first composition of the base metal includes greater than about 80 weight percent of the base metal.

6. The method of claim 5, wherein the second composition of the base metal includes at least about 99.5 weight percent of the base metal.

7. The method of claim 1, wherein the reaction products are carbon dioxide-free.

8. The method of claim 1, wherein operating the discharge cell in the discharge mode includes generating electrical power at the discharge cell.

9. The method of claim 1, wherein operating the discharge cell in the discharge mode includes introducing the oxygen-free oxidant in a gaseous form into the electrolyte.

10. The method of claim 1, wherein operating the discharge cell in the discharge mode includes introducing the oxygen-free oxidant in a liquid form into the electrolyte.

11. The method of claim 1, wherein the one or more components of the reaction products include respective oxidation products of impurities of the first composition of the base metal, and the one or more components of the reaction products include oxidation products of the impurities of the first composition of the base metal.

12. The method of claim 1, wherein the electrolyte includes a molten salt eutectic.

13. The method of claim 12, wherein the molten salt eutectic has a eutectic temperature less than a melting point of the first composition of the base metal in the anode.

14. The method of claim 13, wherein the first composition of the base metal of the anode has a first density, the electrolyte has a second density, the oxygen-free oxidant from the cathode has a third density, the first density is greater than the second density at a temperature below the eutectic temperature of the molten salt, and the second density is greater than the third density at the temperature below the eutectic temperature of the molten salt.

15. A system for purifying metal-containing material, the system comprising:
a discharge cell including an anode, a cathode, and an electrolyte in ionic communication therebetween, the anode including a first composition of a base metal, and the electrolyte including an oxygen-free oxidant;
a distillation module in fluid communication with the electrolyte from the discharge cell and, in the distillation module, an oxidation product of the base metal separable from one or more reaction products in the electrolyte; and
an electrolysis cell in fluid communication with the oxidation product of the base metal separated by the distillation module, the electrolysis cell operable to reduce the oxidation product of the base metal to the oxygen-free oxidant and a second composition of the base metal.

16. The system of claim 15, wherein operation of the electrolysis cell in an electrolysis mode is at least partially powered by electrical power generated by operation of the discharge cell in a discharge mode.

17. The system of claim 15, wherein the electrolyte includes a molten salt.

18. The system of claim 17, wherein the molten salt has a eutectic temperature less than a melting temperature of the base metal.

19. The system of claim 17, wherein the first composition of the base metal of the anode has a first density, the oxygen-free oxidant from the cathode has a second density, and the first density is greater than the second density at a temperature below a eutectic temperature of the molten salt.

20. The system of claim 15, further comprising a return circuit in fluid communication between the electrolysis cell and the discharge cell, wherein the oxygen-free oxidant is flowable from the electrolysis cell to the discharge cell via the return circuit.
